(19) United States
(12) Patent Application Publication
(10) Pub. No.: US 2026/0185828 A1
(43) Pub. Date: Jul. 2, 2026

(54) CHROMATIC RANGE SENSOR SYSTEM WITH ROTATING CALIBRATION OBJECT

(71) Applicant: Mitutoyo Corporation, Kanagawa-ken (JP)

(72) Inventor: Pavel Ivanovich Nagornykh, Kirkland, WA (US)

(21) Appl. No.: 19/002,224

(22) Filed: Dec. 26, 2024

(51) Int. Cl. G01B 21/04; G01B 11/00

(52) U.S. Cl. CPC G01B 21/042; G01B 11/002

(57) ABSTRACT

A system and method provide distance calibration data for a chromatic range sensor system with a chromatic range sensor optical pen configured to focus different wavelengths at different distances along a distance measurement axis. A measuring machine rotates a calibration object (e.g., as positioned on a rotary stage) to achieve relative movement of a calibration surface of the calibration object in relation to the chromatic range sensor optical pen which is coupled to the measuring machine. The chromatic range sensor optical pen is utilized to perform a scan of a portion of the calibration surface as the calibration object is rotated. Distance indicating data is determined as corresponding to the distances between the chromatic range sensor optical pen and surface points on the calibration surface as the scan is performed. Distance calibration data for the chromatic range sensor system is determined based on the distance indicating data.

### BACKGROUND

### Technical Field

The disclosure relates generally to precision measurement instruments, and more particularly to chromatic range sensors such as may be used with measuring machines for determining measurements of workpieces.

### Description of the Related Art

It is known to use chromatic confocal techniques in optical range sensors (e.g., including height, distance, etc., sensors). As described in U.S. Pat. No. 7,876,456 (the '456 patent), which is hereby incorporated herein by reference in its entirety, an optical element having axial chromatic aberration, also referred to as axial or longitudinal chromatic dispersion, may be used to focus a broadband light source such that the axial distance to the focus varies with the wavelength. Thus, only one wavelength will be precisely focused on a surface, and the surface height or distance relative to the focusing element determines which wavelength is best focused. Upon reflection from the surface, the light is refocused onto a small detector aperture, such as a pinhole or the end of an optical fiber. Upon reflection from the surface and passing back through the optical system to the in/out fiber, only the wavelength that is well-focused on the surface is well-focused on the aperture. All of the other wavelengths are poorly focused on the aperture, and so will not couple much power into the fiber. Therefore, for the light returned through the fiber, the signal level will be greatest for the wavelength corresponding to the surface height (i.e., distance) to the surface. A spectrometer-type detector measures the signal level for each wavelength, in order to determine the surface height (e.g., for which the wavelength that is well-focused on the surface will generally form the highest peak in the overall detector signal).

Certain manufacturers refer to practical and compact chromatic range sensing (CRS) systems that operate as described above, and that are suitable for use in an industrial setting, as chromatic point sensors (CPS) or chromatic line sensors, or the like. A compact chromatically-dispersive optical assembly used with such systems is referred to as an “optical pen,” or a “pen.” The optical pen is connected through an optical fiber to an electronic portion of the chromatic range sensor system. The electronic portion includes a light source that transmits light through the fiber to be output from the optical pen, and also provides a spectrometer that detects and analyzes the returned light. The returned light forms a wavelength-dispersed intensity profile received by the spectrometer's detector array. Pixel data corresponding to the wavelength-dispersed intensity profile is analyzed to determine the “dominant wavelength position coordinate” as indicated by a peak or centroid of the intensity profile (e.g., as corresponding to the wavelength that is well-focused on the surface), and the resulting pixel coordinate of the peak and/or centroid is used with a lookup table to determine the distance to the surface. This pixel coordinate may be determined with sub-pixel resolution, and may be referred to as the “distance-indicating coordinate” or “distance indicating pixel coordinate.”

An important issue with chromatic range sensors is the stability of their components relative to their calibration. Chromatic range sensors provide very high resolution and accuracy (e.g. sub-micron resolution and accuracy) based on distance calibration data that correlates known measurement distances with the resulting dominant wavelength position coordinate along the detector array. At the level of resolution and accuracy provided by chromatic range sensors, component behavior inevitably drifts relative to the behavior provided at the time of factory calibration, resulting in measurement errors. Known methods of calibration generally require equipment and/or a level of expertise that is impractical for end-users to provide (e.g., in particular while the chromatic range sensor is attached to a measuring machine, etc.) Thus, if the measurement accuracy degrades, or if a user desires to replace a specific component of the chromatic range sensor (such as the optical pen), the entire unit may need to be sent back to the factory for recalibration. In addition, in some implementations it may be desirable to be able to install or maintain a chromatic range sensor on a measuring machine without prior factory calibration (e.g., for faster delivery, lower preparation costs, etc.). In relation to such issues, providing improved, simplified, and/or more reliable calibration (e.g., for initial calibration and/or recalibration, etc.) for chromatic range sensors (e.g., while attached to a measuring machine, etc.) would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method for determining distance calibration data for a chromatic range sensor system with a chromatic range sensor optical pen that is coupled to a measuring machine is provided. The chromatic range sensor optical pen is configured to focus different wavelengths at different distances proximate to a surface to be measured. The measuring machine is controlled to rotate a calibration object (e.g., that is positioned on a rotary stage of the measuring machine) to achieve relative movement of a calibration surface of the calibration object in relation to the chromatic range sensor optical pen. The chromatic range sensor optical pen is utilized to perform a scan of a portion of the calibration surface as the calibration object is rotated for which distance indicating data is determined as corresponding to distances between the chromatic range sensor optical pen and surface points on the calibration surface as the scan is performed. Distance calibration data for the chromatic range sensor system is determined based at least in part on the distance indicating data.

In some implementations, a system is provided which includes a measuring machine, a chromatic range sensor system and a calibration object. The measuring machine includes a motion controller. The system is configured to utilize the motion controller to rotate the calibration object to achieve relative movement of the calibration surface in relation to the chromatic range sensor optical pen. A scan of the calibration surface is performed for determining distance indicating data which is utilized to determine distance calibration data.

In some implementations, the chromatic range sensor system includes a chromatic range sensor optical pen, an illumination source, a wavelength detector, and a processing portion. The illumination source is configured to generate multi-wavelength input light having an input spectral profile that is input to the chromatic range sensor optical pen. The wavelength detector includes a plurality of pixels with respective pixel positions distributed along a wavelength measurement axis of the wavelength detector. The chromatic range sensor system is configured such that, when the chromatic range sensor optical pen is operably positioned relative to a surface to perform measurement operations, the chromatic range sensor optical pen inputs the input spectral profile and outputs corresponding radiation to the surface and receives reflected radiation from the surface and outputs the reflected radiation to the wavelength detector. The processing portion is configured to determine distance indicating data resulting from rotation of the calibration object by the measuring machine to achieve relative movement of the calibration surface in relation to the chromatic range sensor optical pen. The relative movement of the calibration surface results in the chromatic range sensor optical pen performing a scan of a portion of the calibration surface, from which the distance indicating data is determined as corresponding to distances between the chromatic range sensor optical pen and surface points on the calibration surface as the scan is performed. The distance calibration data is determined based at least in part on the distance indicating data.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an exemplary chromatic range sensor (CRS) system including an optical pen;

FIG. 2 is a diagram of a system noise (bias) profile from a CRS system illustrating wavelength-dependent voltage offset signal levels for the pixels in a detector array when no measurement surface is present;

FIG. 3 is a diagram of an intensity profile from a CRS system illustrating a valid wavelength peak produced by a wavelength reflected by a surface, wherein the pixel position of the peak corresponds to a measurement distance to the surface;

FIG. 4A is a diagram of the first representation of CRS distance calibration data, which correlates distance-indicating pixel coordinates with known measurement distances to a measured workpiece surface;

FIG. 4B is a diagram of a second representation of CRS distance calibration data, comprising an example CRS distance calibration lookup table, which references distance-indicating coordinates (DIC) to corresponding measurement distances of a CRS system;

FIG. 5A is a perspective view showing an implementation of a measuring system including a measuring machine (e.g., a roundness measuring machine) utilized in conjunction with a CRS system for measuring an object;

FIG. 5B is a block diagram showing a structure of a controlling/processing unit for the measuring machine and CRS system of FIG. 5A;

FIGS. 6A-6C illustrate a first implementation of a calibration object;

FIGS. 7A and 7B illustrate second and third implementations of calibration objects;

FIGS. 8A-8C illustrate a fourth implementation of a calibration object;

FIG. 9 illustrates a distance indicating coordinate versus rotation angle curve;

FIG. 10 is a diagram of a representation of CRS distance calibration data; and

FIG. 11 is a flow diagram illustrating one exemplary implementation of a routine for determining distance calibration data for a CRS system.

### DETAILED DESCRIPTION

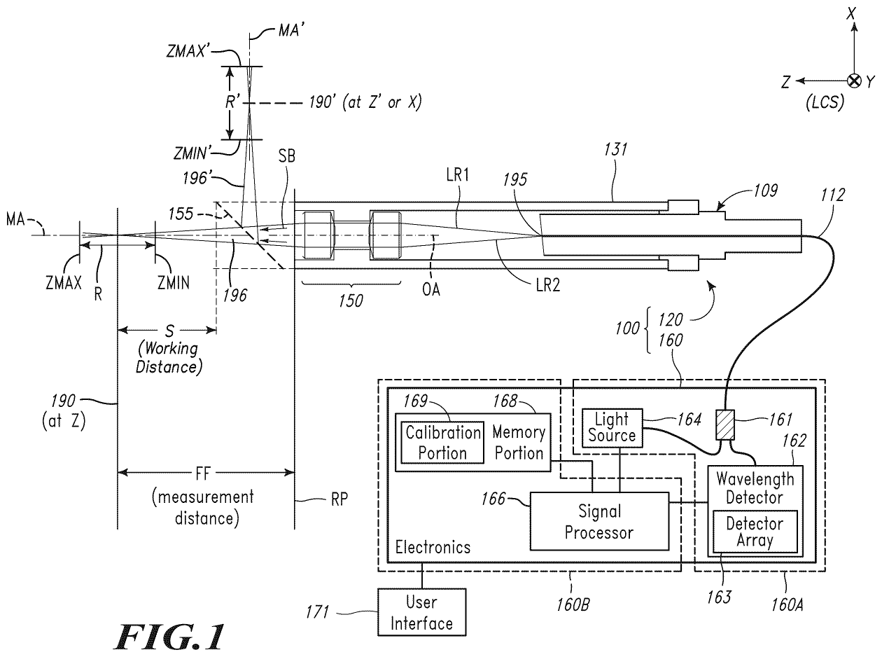

FIG. 1 is a block diagram of an exemplary chromatic range sensor (CRS) system 100 of a first type based on operating principles that are desirable to employ in conjunction with a measuring machine. The CRS system 100 has certain similarities to systems described in U.S. Pat. Nos. 7,876,456; 7,990,522 and 9,329,026 (the '456, '522 and '026 patents, respectively), which are hereby incorporated herein by reference in their entireties. As shown in FIG. 1, the CRS system 100 includes an optical pen 120, an electronics portion 160, and a user interface portion 171. It will be appreciated that the CRS system 100 shown in FIG. 1 is a chromatic point sensor (CPS) system (i.e., for which the optical pen 120 is a chromatic point sensor) which in some instances may measure a single measurement point at a time. However, in various embodiments alternative types of chromatic range sensor systems, such as a chromatic line sensor, may be utilized.

The optical pen 120 includes a fiber optic connector 109, a housing 131 (e.g. an assembly tube), and an optics portion 150. The fiber optic connector 109 is attached to the end of the housing 131. In various implementations, the fiber optic connector 109 may be oriented at an angle relative to the housing 131. The fiber optic connector 109 receives an in/out optical fiber (not shown in detail) through a fiber optic cable 112 which encases it. The in/out optical fiber outputs source light through a fiber aperture 195 and receives reflected measurement signal light through the fiber aperture 195.

In operation, broadband (e.g. white) source light emitted from the fiber end through the fiber aperture 195 is focused by the optics portion 150, which includes a lens or lenses that provide an axial chromatic dispersion, such that the focal point along the optical axis OA is at different distances depending on the wavelength of the light, as is known for chromatic confocal sensor systems. The source light forms a measurement beam 196 that includes a wavelength that is focused on a surface 190 (e.g., a surface of a workpiece or a calibration object, etc.) at a position Z relative to the optical pen 120. Upon reflection from the surface 190, reflected light is refocused by the optics portion 150 onto the fiber aperture 195. The operative source light and reflected light are bounded by the limiting rays LR1 and LR2. Due to the axial chromatic dispersion, only one wavelength will have a front focus dimension FF that matches the measurement distance (e.g., the measurement distance Z) from the optical pen 120 (e.g., from a reference position RP that is fixed relative to the optical pen 120) to the location on the workpiece surface 190. The optical pen is configured such that the wavelength that is best focused at the surface 190 will also be the wavelength of the reflected light that is best focused at the fiber aperture 195. The fiber aperture 195 spatially filters the reflected light such that predominantly the best focused wavelength passes through the fiber aperture 195 and into the core of the optical fiber cable 112. As described in more detail below and in the incorporated references, the optical fiber cable 112 routes the reflected signal light to a wavelength detector 162 that is utilized for determining the wavelength having the dominant intensity, which corresponds to the measurement distance to the surface 190.

FIG. 1 also schematically illustrates an optional reflective element 155 in dashed outline. As described in more detail in U.S. Pat. No. 8,194,251, which is hereby incorporated by reference in its entirety, a reflective element may be placed in the path of the source beam SB. In such an implementation, rather than the measurement axis MA being coaxial with the optical axis OA, the reflective element may direct the measurement beam 196′ along a measurement axis MA′ in a different direction (e.g. orthogonal to the optical axis) as needed in some measurement applications. In such an implementation, the source light forms a measurement beam 196′ that includes a wavelength that is focused on a surface 190′ (e.g., a surface of a workpiece or a calibration object, etc.) at a position (e.g., referenced as a position Z or a position X in some implementations) relative to the optical pen 120. Due to the axial chromatic dispersion, only one wavelength will have a front focus dimension (e.g., a front focus dimension FF′ (not shown) which may be comparable/equal to the front focus dimension FF described above) that matches the measurement distance (e.g., the measurement distance Z′ or X) from the optical pen 120 (e.g., from a reference position RP that is fixed relative to the optical pen 120) to the location on the workpiece surface 190′. More specifically, the front focus dimension and/or the measurement distance Z′ in such a configuration will be understood to be the sum of two distances, including the distance from the reference position RP to the axial position of the reflective element 155, and the distance from the axial position of the reflective element 155 to the workpiece surface 190′ (e.g., for which in the illustrated implementation the two distances are orthogonal to one another). Such an orthogonal orientation is utilized in the embodiments illustrated in other figures herein, as will be described in more detail below. In relation to such implementations, the distance/position Z′ may be simply referenced as a distance/position Z and/or the measurement beam 196′ may be simply referenced as a measurement beam 196, etc.

The electronics portion 160 includes a fiber coupler 161, the wavelength detector 162, a light source 164, a signal processor 166 and a memory portion 168. In various embodiments, the wavelength detector 162 includes a spectrometer or spectrograph arrangement wherein a dispersive optics portion (e.g. a grating) receives the reflected light through the optical fiber cable 112 and transmits the resulting spectral intensity profile to a detector array 163. The wavelength detector 162 may also include related signal processing (e.g. provided by the signal processor 166, in some embodiments) that removes or compensates certain detector-related error components from the profile data. Thus, certain aspects of the wavelength detector 162 and the signal processor 166 may be merged and/or indistinguishable in some embodiments. In various implementations, the signal processor 166 and/or the wavelength detector 162 and/or other signal processors, computing systems, etc., that are utilized for related processing may be referenced as a processing portion of the CRS system 100.

The white light source 164, which is controlled by the signal processor 166, is coupled through the optical coupler 161 (e.g. a 2×1 optical coupler) to the optical fiber cable 112. As described above, the light travels through the optical pen 120 which produces longitudinal chromatic aberration so that its focal length changes with the wavelength of the light. The wavelength of light that is most efficiently transmitted back through the fiber is the wavelength that is in focus on the surface 190 or 190′ at the position Z. The reflected wavelength-dependent light intensity then passes through the fiber coupler 161 again so that approximately 50% of the light is directed to the wavelength detector 162, which may receive a spectral intensity profile distributed over an array of pixels along a wavelength measurement axis of the detector array 163, and operate to provide corresponding profile data as described in more detail in the incorporated references.

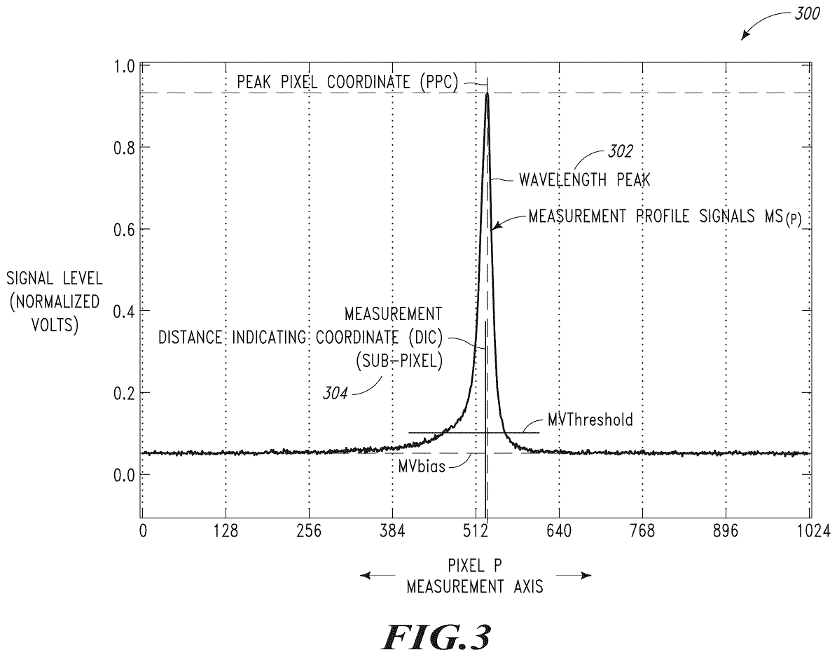

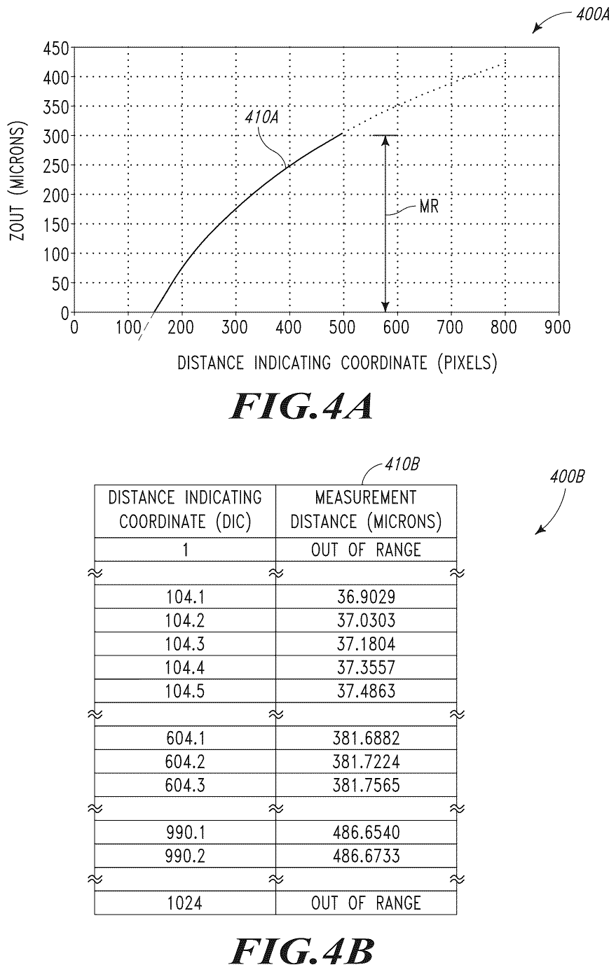

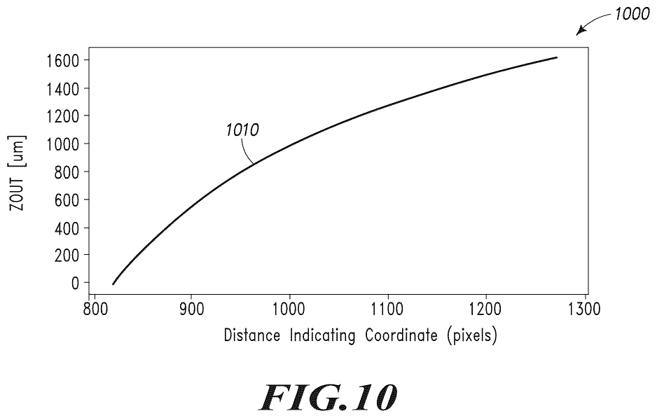

Briefly, the subpixel-resolution distance-indicating coordinate (DIC) of the profile data (e.g., see FIG. 3) is calculated by the signal processor 166, and the DIC (in subpixels) indicates the measurement distance Z to the location on the surface 190 or 190′ (in microns) via a distance calibration lookup table or the like, which is stored in a calibration portion 169 of the memory portion 168, (e.g., as described below with respect to FIGS. 4A, 4B and 10). In accordance with previously known methods, the DIC may be determined by various techniques (e.g., in accordance with the centroid of the intensity profile data included in a peak region, etc.) In various implementations, the profile data may be used to determine the DIC with subpixel resolution, as will be described in more detail below.

The optical pen 120 generally has a measurement range R that is bound by a minimum range distance ZMIN and a maximum range distance ZMAX. The measurement range R in some example instances of known optical pens may be approximately 1/10th of the nominal standoff or working distance from the end of the pen (e.g. in the range of tens of microns to a few millimeters). In various implementations, the measurement range R may also or alternatively be referenced as, and/or may be equal to, a working range (e.g., a working range WR) of the optical pen 120. FIG. 1 schematically illustrates that if the reflector element 155 is used, a measurement range R′ (e.g., which may be equal to the measurement range R) may be directed along a measurement axis MA′ determined by the placement of the reflector element 155. In such a case, the measurement range R′ may be bound by a minimum range distance ZMIN′ and a maximum range distance ZMAX′. In various implementations, the measurement range R′ may also or alternatively be referenced as, and/or may be equal to, a working range (e.g., a working range WR of the optical pen 120). In various implementations, the minimum and maximum range distances ZMIN′ and ZMAX′ may also or alternatively be referenced as simply ZMIN and ZMAX, or XMIN and XMAX (e.g., in accordance with a coordinate system in which the measurement axis MA′ is referenced along an x-axis direction).

It should be appreciated that in some implementations the electronics portion 160 may be located away from the optical pen 120. For example, it has been known to mount an optical pen analogous to the optical pen 120 shown in FIG. 1 on a CMM using a customized bracket, and to route an optical fiber analogous to the optical fiber cable 112 along a makeshift path on the outside of CMM components to a remotely located electronics analogous to the electronics portion 160.

In various implementations, a group of components in a light source and wavelength detector portion 160A (e.g. including the wavelength detector 162 and light source 164) may be included inside an optical probe assembly in some embodiments. A group of components in a measurement signal processing and control circuit 160B (e.g. including the signal processor 166 and memory portion 168) may be located remotely outside of the optical probe assembly, if desired (e.g. to maintain low probe weight and compact probe size).

As further illustrated in FIG. 1, the user interface portion 171 is coupled to the electronics portion 160 and provides a user interface that is configured to receive user input used for the operation of the CRS system 100, such as a user command to select various operating parameters, via any suitable means such as a keyboard, touch sensor, mouse, etc. In exemplary embodiments, the user interface portion 171 may include one or more operation mode selecting elements (e.g., user-selectable buttons) operable by a user to select one of a plurality of operation modes of the CRS system 100 (e.g., a measurement mode, a calibration mode, etc.) The user interface portion 171 is also configured to display information on a screen, such as one or more distances successfully determined/measured by the CRS system 100.

FIG. 1 includes orthogonal XYZ coordinate axes, as a frame of reference (e.g., as part of a local coordinate system (LCS) of the optical pen 120/CRS system 100). The Z direction may be defined to be parallel to the measurement axis MA which is coaxial with the optical axis (OA), which may be a distance measurement axis, of the optical pen 120. As illustrated in FIG. 1, during operation, the surface 190 (e.g., of a workpiece or calibration object to be measured) is located/placed along the measurement axis MA which is coaxial with the optical axis OA. Alternatively, in an implementation where the reflector element 155 is used, a surface 190′ (e.g., of a workpiece or calibration object to be measured) is located/placed along the measurement axis MA′. In some such implementations, a Z direction (e.g., as corresponding to a measurement distance Z) may be defined to be parallel to the measurement axis MA′ (e.g., as part of the local coordinate system (LCS) of the optical pen 120/CRS system 100, for which the z-axis and Z direction may be the primary axis/direction of interest in relation to measurements of the optical pen 120, for which the Z direction may correspond to the optical axis of the optical pen 120, which is the distance measurement axis of the optical pen 120).

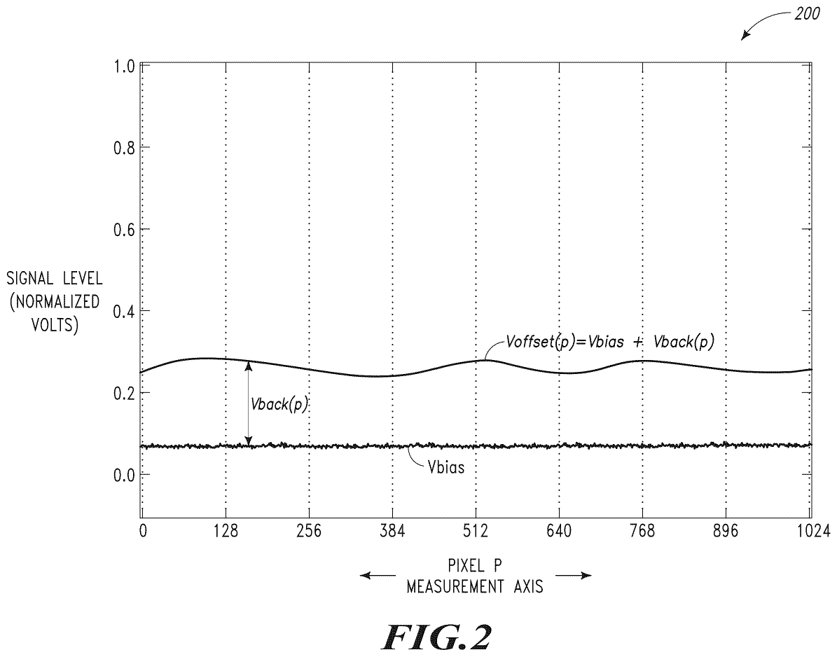

The following description of FIG. 2 outlines certain known background signal processing and/or calibration operations. FIG. 2 is a diagram 200 of a system noise (bias) profile from a CRS system, illustrating voltage offset signal levels Voffset(p) for the pixels in a detector array (see detector array 163 of FIG. 1) when no measurement surface is present within the nominal total measurement range of the CRS system. In such a case, there is no intentionally reflected light and hence no significant or dominant wavelength peak in the resulting intensity profile. The voltage offset signal Voffset(p) is plotted in normalized volts, for each of 1,024 pixels along the wavelength measurement axis of the detector array 163. “Normalized volts” assigns a value of 1.0 to the saturation voltage of the detector array 163. The voltage offset signal Voffset(p) includes a bias signal level Vbias, which is relatively consistent across the detector array, and a background signal component Vback(p), which is shown as varying across the detector array.

The variable background signal Vback(p) represents signals such as background light from wavelength-dependent spurious reflections and the like in the chromatic point sensor, as well as due to the dark current of the various pixels p. In various embodiments, it is advantageous if the signal components Vback(p) (or signals that show the same variation, such as the voltage offset signals Voffset(p)) are stored for calibration or compensation of the pixel array of the detector array 163, and used to compensate all subsequent profile data signals from each pixel p (e.g. by subtraction), on an ongoing basis. Thus, it will be understood that the background signal component Vback(p) is assumed to be compensated in a known manner in various embodiments, and it is not necessary that it be further explicitly considered or described in relation to the various intensity profiles or signal processing operations, or the like, described below.

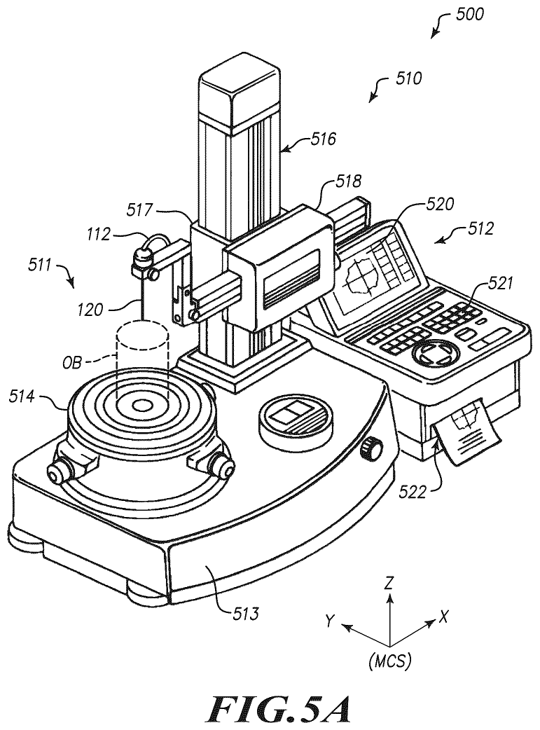

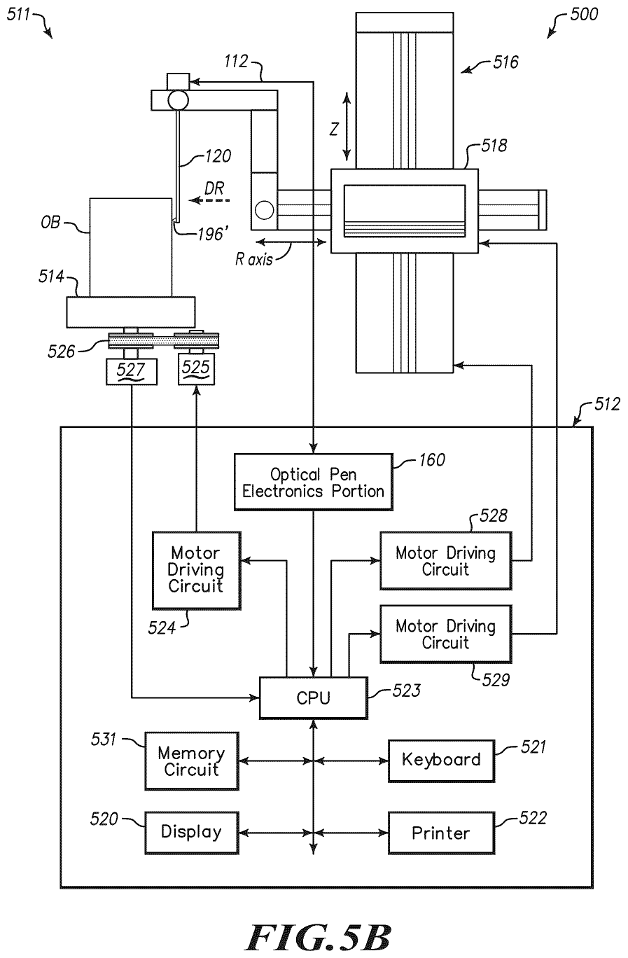

The following description of FIGS. 3, 4A and 4B outlines certain signal processing operations that determine distance-indicating coordinates (DIC) with subpixel resolution based on valid wavelength peaks produced in wavelength-dispersed intensity profiles from the CRS system and determine measurement distances to surfaces (e.g., in microns) based on the determined DICs. Certain previously known operations outlined here are described in more detail in the '456 patent, while certain alternative operations as disclosed herein are described in more detail below with respect to FIGS. 5A-11. The purpose of this description is to provide information which is useful for an overall understanding of certain CRS measurement operations as described herein.

FIG. 3 is a diagram 300 of a wavelength-dispersed intensity profile from a CRS system illustrating a valid wavelength peak 302 produced by a subset of measurement profile signals MS(p) indicative of a wavelength focused on and reflected by a surface (e.g., of a calibration object or a workpiece, etc.) As previously noted, as part of the standard operations for CRS systems, the signal level will be greatest for the wavelength corresponding to the surface height or distance to the surface, for which the wavelength that is well-focused on the surface will generally form the highest peak in the overall detector signal. In the example of FIG. 3, the diagram 300 includes a wavelength peak 302 corresponding to a measured surface. Each of the measurement profile signals MS(p) has the signal level (shown in normalized volts) associated with each pixel p of the detector array (e.g., the detector array 163). The wavelength peak 302 has more than sufficient height (a good signal to noise ratio), is relatively symmetric, and allows a good estimation of the peak location or measurement distance-indicating coordinate (DIC) 304 along the wavelength measurement axis of the detector array. FIG. 3 also shows a bias signal level MVbias (in normalized volts), a peak pixel coordinate (ppc), and a data threshold MVthreshold that defines the lower limit of a distance-indicating subset of measurement profile signals MS(p) forming the wavelength peak 302. All values (e.g., including “MV” values) are in normalized volts.

Briefly, in one embodiment, measurement operations for determining a distance-indicating coordinate (DIC) (in pixels) and determining a corresponding measurement distance (in microns) based on the determined DIC may include the following:
Position the target surface along the optical axis OA, and capture the resulting wavelength-dispersed intensity profile as in the diagram 300.
Determine the peak pixel coordinate (ppc), which is the pixel that has the highest signal.
Determine the measurement bias signal level MVbias at a given sampling rate.
Determine the data threshold MVthreshold (e.g., as a percentage of the peak height).
Determine the distance-indicating coordinate (DIC) with sub-pixel resolution, based on the distance-indicating subset of measurement profile signals MS(p) forming the wavelength peak that has a value greater than MVthreshold.
Determine the measurement distance by correlating the DIC with a corresponding distance in the stored distance calibration data (e.g., a distance calibration curve as in FIG. 4A or FIG. 10, or a lookup table as in FIG. 4B, etc.).

In the foregoing operations, a DIC may be determined with sub-pixel resolution, based on the distance-indicating subset of measurement profile signals MS(p) above the data threshold MVthreshold. In accordance with previously known methods, a DIC may be determined as the subpixel-resolution coordinate of a centroid X_{C} of the distance-indicating subset of signals MS(p). For example, for a detector with 1024 pixels (i.e., each having a corresponding pixel number (p) from 1 to 1024), the centroid X_{C} may be determined according to:

$$Xc = \frac{{\sum }_{p = 1}^{1024} {p ( {S}_{M} ( p ) )}^{n}}{{\sum }_{p = 1}^{1024} {( {S}_{M} ( p ) )}^{n}} \qquad ( Eq . 1 )$$

where,

$${S}_{M} ( p ) = \{ \begin{matrix}{MS}_{p} - MVThreshold ( ppc ) , for {MS}_{p} \geq MVThreshold ( ppc ) \\ 0 , for {MS}_{p} < MVTThreshold ( ppc )\end{matrix} \} \qquad ( Eq . 2 )$$

In one specific example, n=2 in EQUATION 1. It will be appreciated that EQUATION 2 restricts the signals MS(p) used in the centroid calculation to a distance-indicating subset.

FIG. 4A is a diagram 400A of a first representation of CRS measurement distance calibration data 410A which correlates distance-indicating coordinates (DIC) with sub-pixel resolution to known measurement distances (ZOUT) in microns along the optical axis (OA) of the CRS system (e.g., as stored in the calibration portion 169 of FIG. 1). It will be appreciated that the specific values of FIG. 4A are intended to be illustrative only, and may not correspond to specific values indicated in other examples (e.g. in relation to certain values described with respect to FIGS. 1-3 and/or the specific table values of FIG. 4B as will be described in more detail below, although it will be appreciated that the concepts are analogous). The example shown in FIG. 4A is for an optical element (e.g., optical pen) having a nominal total measurement range MR of approximately 300 microns, which corresponds to DICs in the range of approximately 150 pixels-490 pixels. However, the CRS system may be calibrated over a larger pixel range and/or different portion of the detector array 163, if desired. Although the distance calibration data 410A appears to form a smooth curve, it will be appreciated that in some instances the distance calibration data and/or output spectral profile data for a typical CRS system, particularly for economical CRS systems, may exhibit certain short range variations/irregularities (e.g., as described in part in the '456 patent).

One exemplary laboratory calibration method (e.g., as may be utilized for factory calibration, etc.) to determine the CRS measurement distance calibration data 410A and/or 410B employs a mirror (e.g., which in one example implementation may be the surface 190 or 190′ of FIG. 1) moved along the optical axis OA. The displacement of the mirror along the optical axis OA relative to the optical pen may be controlled (e.g., by a stepper motor, etc.) which steps the calibration measurement distance in approximately equal steps (e.g., 0.1 or 0.2 micron steps). For each step, the actual mirror position or displacement is acquired using a reference standard, such as an interferometer. For each actual mirror position, the calibration distance indicating coordinate of the CRS system is determined, based on the corresponding intensity profile data provided by the CRS detector. The calibration distance indicating coordinate and the corresponding actual position are then recorded to provide the distance calibration data 410A and/or 410B. While such techniques may be utilized to provide accurate distance calibration data (e.g., as part of a factory calibration process), certain alternative techniques as disclosed herein (e.g., as will be described in more detail below with respect to FIGS. 5A-11) may also or alternatively be utilized in certain implementations, for which such alternative techniques may have certain advantages.

After the distance calibration data has been determined, during later measurement operations, to determine a measurement distance to a workpiece surface (e.g. surface 190 or 190′ of FIG. 1), the workpiece surface is positioned along the optical axis OA of the CRS optical pen. The measurement distance indicating coordinate of the CRS is determined, based on the measurement DIC determined from the intensity profile data provided by the CRS detector. Then, the distance calibration data (e.g., such as distance calibration data 410A, 410B, or 1010) is used to determine the CRS measurement distance Z that corresponds to that specific measurement DIC.

FIG. 4B is a diagram 400B of a second representation of CRS distance calibration data 410B comprising a CRS distance calibration lookup table for referencing distance-indicating coordinates to measurement distances for a chromatic point sensor (e.g., as stored in the calibration portion 169 of FIG. 1). As noted above, it will be appreciated that the table values of FIG. 4B are intended to be illustrative only, and may not correspond to specific values indicated in other examples, such as those of FIG. 4A, although for which it will be appreciated that the concepts are analogous. In general, it will be appreciated that a same set of distance calibration data may be represented as both a curve (e.g., as illustrated in FIGS. 4A and 10) or a table (e.g., as illustrated in FIG. 4B) and that the distance calibration data utilized to form one such type of representation may similarly be utilized to form the other type of representation and/or other representations.

In FIG. 4B, in the left column the calibration DICs entries cover the pixel coordinates from 1 to 1,024, in increments of 0.1 pixel steps, and in the right column the corresponding measurement distances (in microns) (ZOUT) are entered. In operation, the measurement DIC calculated by the CRS system is referenced to the stored calibration lookup table in order to determine the corresponding measurement distance (in microns). If the measurement DIC falls between adjacent calibration DIC values, then the measurement distance may be determined, for example, by interpolation. In the example of FIG. 4B, some specific example values are shown for some small ranges near DICs with pixel positions of approximately 104, 604 and 990, with corresponding measurement distances in ranges near 37 microns, 381 microns and 486 microns.

In operation (e.g., for a measurement distance to a surface 190 or 190′ as illustrated in FIG. 1), the optical pen 120 is connected to the CRS electronics portion 160 and operably positioned relative to the surface 190 or 190′ to perform measurement operations. The measurement operations include the optical pen 120 inputting an input spectral profile from the illumination source 164 and outputting corresponding radiation to the surface 190 or 190′ and receiving reflected radiation from the surface 190 or 190′ and outputting the reflected radiation to provide an output spectral profile to the CRS wavelength detector 162, which then provides output spectral profile data. The output spectral profile includes a distance-dependent profile component and a distance-independent profile component. The distance-dependent profile component has a wavelength peak (e.g., peak 302 in FIG. 3) that indicates a measurement distance (e.g., measurement distance Z) from the optical pen 120 to the surface 190 or 190′. As described above, the measurement DIC that is determined in accordance with a centroid calculation by the CRS system is referenced to the stored distance calibration data (e.g., FIG. 4A, 4B, or 10) in order to determine the measurement distance (e.g., measurement distance Z which is a value ZOUT) corresponding to the measurement DIC. If the measurement DIC falls between adjacent calibration DIC values, then the measurement distance corresponding to the measurement DIC may be determined by interpolation (e.g., between the measurement distances corresponding to the adjacent calibration DIC values).

FIG. 5A is a perspective view showing an implementation of a measuring system 500 including a measuring machine 510 utilized in conjunction with a CRS system 100 (i.e., including an optical pen 120) for measuring an object OB (e.g., a calibration object or a workpiece). FIG. 5B is a block diagram showing a structure of a controlling/processing unit 512 for the measuring machine 510 and CRS system 100 (i.e., including an optical pen electronics portion 160) of FIG. 5A. In various implementations, the measuring machine 510 may be a roundness measuring machine (e.g., which in various implementations may also or alternatively be in the form of or otherwise referenced as a roundness tester and/or a cylindrical coordinate measuring machine). The measuring machine 510 comprises a measurement unit 511 for measuring the form of the surface of the object OB, and a controlling/processing unit 512 for controlling the measurement operation of the measurement unit 511 and for processing position data which is obtained through the measurement.

The measurement unit 511 comprises a base 513 fixedly placed on a desired horizontal plane. The base 513 includes a rotary stage 514 (e.g., a rotary table) for rotating the object OB at a constant speed around an axis of rotation (e.g., an axis of measurement) which is perpendicular to the horizontal plane, and a head driving mechanism 516 for moving an optical pen 120, for detecting the form of the surface of the object OB, within a predetermined plane including the axis of rotation. The head driving mechanism 516 has a Z axis guiding means 517 for guiding the optical pen 120 along the Z axis (e.g., of an XYZ machine coordinate system (MCS) of the measuring machine 510), which is parallel to the axis of rotation, and an R axis guiding means 518 for guiding the optical pen 120 along the R axis, which is a diametrical line passing through the axis of rotation. The optical pen 120 is moved in a direction DR to be proximate to the object OB, such that a surface of the object is within the measuring range R′ of the optical pen 120 (e.g., as described above with respect to FIGS. 1-4B, and for which the surface of the object OB may correspond to the surface 190′ in FIG. 1, etc.). In various implementations, as part of a calibration process as described herein, the position of the optical pen 120 may be adjusted so that the measuring range R′ of the optical pen 120 will be within the variance of the position of the surface of the calibration object OB as it is rotated (e.g., such as may be determined/performed during a setup process which may include rotating the object while measurement signals are received from the optical pen 120 and the position of the optical pen 120 and/or the object is adjusted accordingly, and in certain implementations may include making adjustments such that a center of the measuring range R′ may be approximately positioned at a center of a variance of the position of the surface).

The controlling/processing unit 512 comprises a display 520 for displaying various data, a keyboard 521 through which a user inputs various information, and a printer 522 for printing out data or the like as required. The controlling/processing unit 512 further comprises, as shown in FIG. 5B, a CPU 523 for controlling the operation of the rotary stage 514 and head driving mechanism 516, and for processing the obtained position data through calculation. The CPU 523 outputs a rotary stage driving command, which is supplied to a first motor driving circuit 524 so as to drive a motor 525. The driving force of the motor 525 is transmitted, via a driving force transmission mechanism 526, to the driving axis of the rotary stage 514. The rotation angle of the rotary stage 514 is detected by a rotary encoder 527, which then supplies a rotation angle signal (e.g., in the form of a digital signal) corresponding to the detected rotation angle to the CPU 523.

In various implementations, the CPU 523 adjusts the position of the optical pen 120. When a Z axis driving command from the CPU 523 is supplied to a second motor driving circuit 528, a movement mechanism (e.g., a pulse motor, not shown), which is incorporated in the Z axis guiding means 517, is activated. The driving force of the movement mechanism drives the optical pen 120 along the Z axis so as to position the optical pen 120. When an R axis driving command from the CPU 523 is supplied to a third motor driving circuit 529, a movement mechanism (e.g., a pulse motor, not shown), which is incorporated in the R axis guiding means 518, is activated. The driving force of the movement mechanism drives the optical pen 120 along the R axis so as to position the optical pen 120.

The CPU 523 receives, via an optical pen electronics portion 160, a measurement signal (e.g., in the form of a digital signal) from the optical pen 120. In various implementations, an optical fiber (e.g., of an optical fiber cable 112) connects the optical pen 120 to the optical pen electronics portion 160. The received measurement signal from the optical pen electronics portion 160 is stored in a memory circuit 531 along with the rotation angle signal from the rotary encoder 527. The two signals (e.g., digital signals) constitute position data regarding the form of the surface. In various implementations, the stored position data are input to the CPU 523. In various implementations, the CPU 523 may calculate a mean circle according to the known method of least squares or minimum area (zone). The roundness and coaxiality may be calculated based on the calculated mean circle. The result of the calculation may be displayed on the display 520, output via the printer 522, or reported to the outside via a communication line and/or wirelessly, not shown.

Some example standard measuring operations of the measuring machine may be performed as follows (e.g., in this example for measuring the coaxiality of the outer surface, etc.). The central axis of the object OB may be manually or automatically coincided with the axis of rotation of the rotary stage 514 in a first step (e.g., utilizing adjustment mechanisms for adjusting the position of the object OB on the rotary stage 514). The operator programs a movement path of the optical pen 120 via the keyboard 521 in a second step. In this step, attention is required to prevent the optical pen 120 from striking/colliding with the object OB. As part of the movement path, the optical pen 120 is moved proximate to a measurement location on the object OB as a third step, so that position data is obtained regarding the roundness at the measurement location (e.g., as defined on the outer surface of the object OB). For the measurement, the coordinates (R, Z) of the measurement location on the object OB that the optical pen 120 is moved proximate to may be given the coordinates for an ideal surface of the object OB. Finally in a fourth step, a mean circle may be calculated for the measurement location on the basis of the obtained position data (e.g., utilizing a method of least squares or minimum zone, etc.). In various implementations, using the obtained mean circle as a reference, the roundness of the object OB may be calculated. In various implementations, the position data indicating the roundness of the outer surface may be displayed.

The following describes part of the process noted above that is followed for obtaining the position data. For the measurement location noted above, the CPU 523 initially drives the optical pen 120 to the measurement location along the programmed movement path. The CPU 523 then rotates the rotary stage 514 at a constant speed. The rotation angle of the rotary stage 514 is detected by the rotary encoder 527, and is input as a rotation angle signal to the CPU 523 (e.g., in some implementations at an equal/regular interval). The optical pen 120 outputs a measurement signal for every output of the rotation angle signal for an input to the CPU 523. The CPU 523 stores the rotation angle signal and the measurement signal in the memory circuit 531 as position data.

As will be described in more detail below, in various implementations the measuring machine 510 may be utilized as part of a method for providing distance calibration data for the chromatic range sensor system 100 with the chromatic range sensor optical pen 120. The object described above may be a calibration object OB (e.g., which in various implementations may be any one of the calibration objects OB1, OB2A, OB2B or OB3 as described in more detail below). The measuring machine rotates the calibration object OB to achieve relative movement of a calibration surface of the calibration object OB in relation to the chromatic range sensor optical pen 120. The chromatic range sensor optical pen 120 is utilized to perform a scan of a portion of the calibration surface as the calibration object OB is rotated (e.g., as described above and as results from the rotation of the calibration object OB in front of the measurement beam 196′ of the optical pen 120). Distance indicating data is determined as corresponding to the distances between the chromatic range sensor optical pen 120 and surface points on the calibration surface as the scan is performed. Distance calibration data for the chromatic range sensor system is determined based at least in part on the distance indicating data.

In general, the various blocks outlined above may be configured using components and operations that are similar or identical to those used for similar operations in certain previously known systems. It will be appreciated that in various embodiments, the operations of the blocks outlined above may be carried out using general purpose processors or the like, and that in various embodiments the circuits and/or routines associated with various blocks may be merged or indistinguishable. Operations for utilizing the optical pen 120 for scanning the calibration object OB for obtaining distance calibration data for the CRS system 100 (e.g., such as distance calibration data 410A, 410B or 1010) will be described in more detail below.

As noted above, when an optical pen 120 and/or controller of a chromatic range sensor system needs to be exchanged (e.g., due to a system upgrade, damaged part replacement, etc.), it is convenient for an end user to be able to have the chromatic range sensor system recalibrated on-site. By following the processes as described below, such on-site calibration may be performed (e.g., without requiring the chromatic range sensor system or its sub-components to be sent back to a manufacturer or servicer for recalibration, etc.).

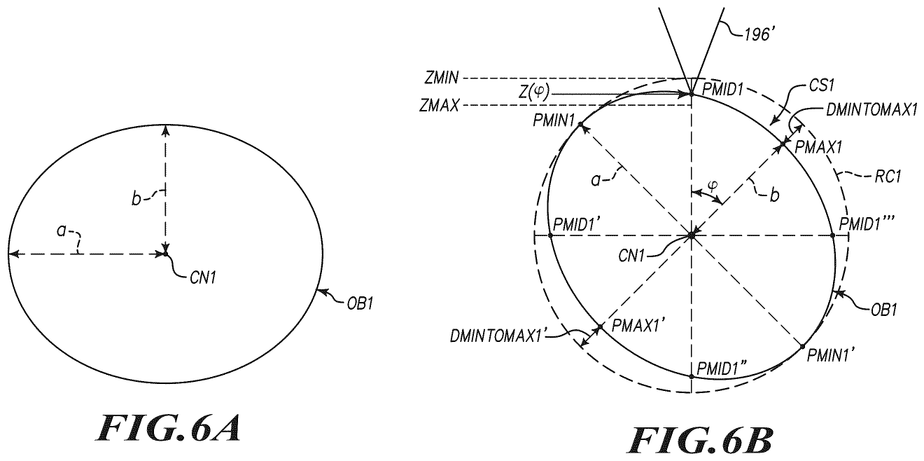

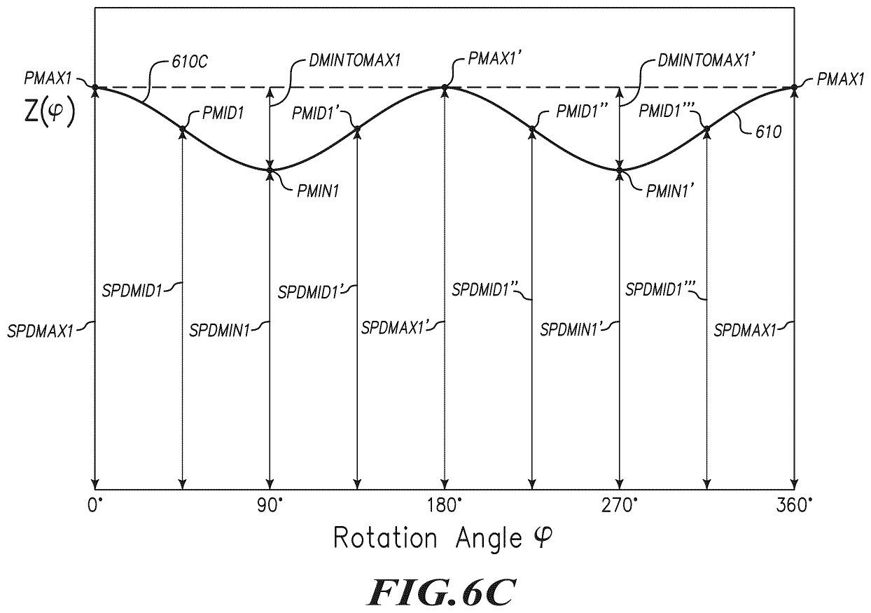

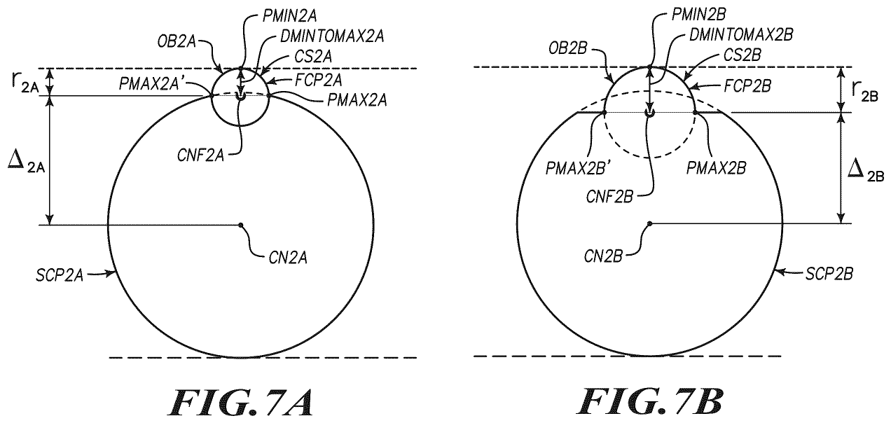

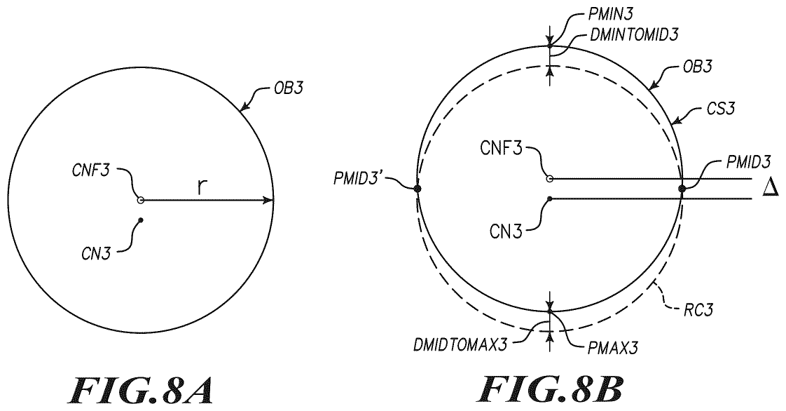

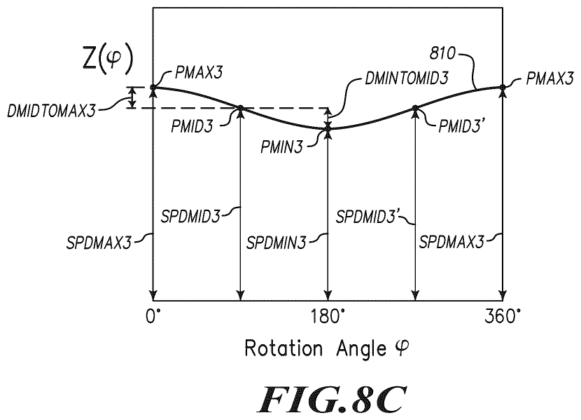

It will be appreciated that a measuring machine (e.g., a roundness measuring machine) as described herein may have a sufficient level of accuracy (e.g., with a precise rotary encoder for determining highly accurate angular orientations of a rotary stage, etc.) for ensuring that a calibration process may be accurately performed for a chromatic range sensor system. As described herein, a calibration object may be utilized for performing a calibration process. As some examples, in various implementations a calibration object may be utilized that has a known ellipticity (e.g., see calibration object OB1 of FIGS. 6A-6C), or that is a hybrid of two precisely machined parts (e.g., such as at least portions of cylinders of different sizes, see calibration objects OB2A and OB2B of FIGS. 7A and 7B), or with a known shape (e.g., a circular cylinder) and that may be positioned to be offset by a known distance (e.g., relative to a center position of a rotary stage, see calibration object OB3 of FIGS. 8A-8C).

As will be described in more detail below, as part of a calibration process, a calibration object may initially be centered on a measuring machine (e.g., as centered on a rotary stage of the measuring machine). In some implementations, after the initial centering is performed, the calibration object (e.g., see calibration object OB3 of FIGS. 8A-8C) may be moved by a known distance to be offset from the center position. In either case, in various implementations, as the calibration object is rotated (e.g., by rotating the rotary stage on which the calibration object is located), distance indicating data may be collected/determined. The distance indicating data may include distance indicating coordinates (e.g., such as corresponding to chromatic range sensor peak position data), and may be collected/determined as a function of the rotation angle of the calibration object/rotary stage. Distance calibration data for the chromatic range sensor system may then be determined based at least in part on the distance indicating data (e.g., a calibration table or curve may be determined/calculated by converting the rotation angles that are associated with the distance indicating coordinates to measurement distances based on the known geometry of the calibration object, for which the measurement distances are correspondingly associated with the distance indicating coordinates for future use in determining measurements).

FIGS. 6A-6C illustrate a first implementation of a calibration object OB1. As illustrated in FIG. 6A which shows a top view, the calibration object OB1 is an elliptical cylinder (e.g., which may be utilized as the cylindrical calibration object OB as shown in the side view of FIG. 5B, and as illustrated in FIG. 5A). In the top view of FIG. 6A, the calibration object OB1 (e.g., and/or a corresponding horizontal cross-section thereof) is shown to be in the shape of an ellipse, and has a semi-major axis “a”, and a semi-minor axis “b”. The calibration object OB1 also has a height “h” (e.g., not shown, which may be similar to the height as illustrated for the object OB in FIGS. 5A and 5B in some implementations, or any other height that enables the calibration object OB1 to be measured by the measuring machine 510 and utilized for the calibration processes as described below). The calibration object OB1 is also illustrated with a center of rotation CN1 (e.g., as may correspond to a desired/positioned center of rotation when the calibration object OB1 is “centered” or otherwise positioned on the rotary stage 514 of the measuring machine 510 of FIGS. 5A and 5B).

As illustrated in FIG. 6B, which is also a top view, the measurement beam 196′ (i.e., of the optical pen 120) is directed toward the side of the calibration object OB1 (e.g., similar to the illustration for the optical pen 120 with the measurement beam 196′ as directed to the side of the object OB in FIG. 5B, for which the measurement beam 196′ may be directed to a particular measurement location/measurement height on the side of the cylindrical calibration object, etc.). In the view of FIG. 6B, the measurement beam 196′ is illustrated at the top of the figure (e.g., in a “12 o'clock” position). In various implementations, a similar convention for a position of the measurement beam 196′ may be designated/assumed for other similar figures herein (e.g., FIGS. 7A, 7B and 8B), in which the measurement beam 196′ may not otherwise be shown, but will be understood to be in the corresponding location and for which the calibration objects may be rotated relative to the measurement beam 196′ in a similar manner as that illustrated for FIG. 6B, as will be described in more detail below.

At a start of a calibration process, the calibration object OB1 may be positioned on the rotary stage (e.g., rotary stage 514) of the measuring machine, and may be centered or otherwise positioned (e.g., such that the center of rotation CN1 of the calibration object OB1 is aligned with an axis of rotation or otherwise at a center of rotation of the rotary stage). As part of a process for such positioning/centering, the calibration object OB1 may initially be placed on the rotary stage, and then the rotary stage may be rotated (i.e., to correspondingly rotate the calibration object), and measurements may be taken (e.g., from the CRS system/optical pen or otherwise) of the calibration surface to determine if the calibration object is centered. If centering has not yet been achieved, the position of the calibration object on the rotary stage may be further adjusted, and if needed the process may be repeated until an acceptable centering of the calibration object is achieved. In various implementations, the optical pen may be positioned/located in relation to the calibration object OB1 (e.g., in some implementations the position of the optical pen 120 may be adjusted after the calibration object OB1 has been positioned/centered on the rotary stage, so that the working range WR/measurement range R of the optical pen 120 falls within a surface point distance range SPDR1 of the calibration object OB1, as will be described in more detail below).

A rotation angle of the rotary stage may correspond to a rotation angle of the calibration object OB1. In one example, the calibration object/rotary stage may be regarded as having a rotation angle of 0 degrees in a particular orientation (e.g., in the orientation illustrated in FIG. 6A). Thereafter, once rotation begins, the rotation angle φ may be in relation to the initial/0 degree orientation (e.g., as illustrated in the example of FIG. 6B). For the calibration object OB1 (i.e., in the shape of an elliptical cylinder), as the rotation progresses, different surface points on the calibration surface CS1 of the calibration object OB1 will be at different distances from the optical pen 120 (i.e., as the surface points are rotated to be in front of the measurement beam 196′, such as aligned with the measurement axis MA′ at the center of the measurement beam 196′ as illustrated in FIG. 1). In various implementations, a Z-distance/Z-height of a surface point may be expressed as a function of the rotation angle φ, for which the Z-distance/Z-height of a surface point may be expressed according to Z(φ). In various implementations, an equation that may be utilized to represent a relationship between the Z-distance/Z-height Z(φ) and the rotation angle φ of the calibration object OB1 may be expressed as:

$$Z ( φ ) - {Z}_{offset} = \frac{ab}{\sqrt{{a}^{2} {sin}^{2} ( φ - {φ}_{offset} ) + {b}^{2} {cos}^{2} ( φ - {φ}_{offset} )}} \qquad ( Eq . 3 )$$

where φ is an angle of rotation, φ_{offset} is an offset angle at which one of the axes of the system aligns with one of the semi-axes of the calibration object OB1, a and b are the semi-major and semi-minor axes of the calibration object OB1 (i.e., in relation to the elliptical shape of the calibration object OB1), Z_{offset} is a value that can be varied to set a center of the CRS working range to correspond to a specific pixel position (e.g., for which the wavelength detector 162 with the detector array 163 includes the plurality of pixels with respective pixel positions distributed along a wavelength measurement axis of the wavelength detector).

It will be appreciated that in various implementations where the working range WR is much smaller than the semi-axes a or b (e.g., in a specific implementation where a=21 mm, b=20 mm and WR=0.5 mm) the above EQUATION 3 may in some implementations be simplified to:

$$Z ( φ ) - {Z}_{offset} \approx b + ( a - b ) {cos}^{2} ( φ - {φ}_{offset} ) \qquad ( Eq . 4 )$$

In various implementations, the values of a and b for the calibration object OB1 may be selected/designated (e.g., in relation to the fabrication of the calibration object OB1 or otherwise) to allow for a calibration of the CRS system with the optical pen 120, such that it may be desirable for the difference between a and b to be at least as large as the working range WR/measurement range R that is to be calibrated, as will be described in more detail below.

As part of such configurations and in relation to the above equations, as some illustrative examples, there may be one or more surface points that will be at a maximum surface point distance SPDMAX from the optical pen 120, and one or more surface points that will be at a minimum surface point distance SPDMIN from the optical pen 120, and one or more surface points that may be at a mid surface point distance SPDMID from the optical pen 120 (e.g., as will be described in more detail below with respect to FIG. 6C). In relation to the illustration of FIG. 6B, the calibration surface CS1 may correspondingly have surface points PMAX1 and PMAX1′ that will be at a maximum surface point distance (e.g., and for which a line through the surface points PMAX1 and PMAX1′ may correspond to/be along the same direction as the semi-minor axis b of the calibration object OB1). The calibration surface CS1 may also correspondingly have surface points PMIN1 and PMIN1′ that will be at a minimum surface point distance (e.g., and for which a line through the surface points PMIN1 and PMIN1′ may correspond to/be along the same direction as the semi-major axis a of the calibration object OB1). The calibration surface CS1 may also correspondingly have surface points PMID1, PMID1′, PMID1″ and PMID1″′ that will be at surface point distances SPDMID1, SPDMID1′, SPDMID1″ and SPDMID1″′ (e.g., in various implementations close to half-way between the maximum and minimum surface point distances, but not exactly half-way).

In various implementations, a surface point distance range SPDR may correspond to a difference between the maximum and minimum surface point distances (e.g., SPDR1=SPDMAX1−SPDMIN1). In various implementations, the surface point distance range SPDR1 may also or alternatively be referenced as a minimum-to-maximum surface point distance DMINTOMAX1 (e.g., as illustrated in FIGS. 6B and 6C). In the example of FIG. 6B, where the variables a and b correspond to the semi-major and semi-minor axes of the elliptical calibration object OB1, the difference between the variables a and b may be equal to the surface point distance range SPDR (e.g., a−b=SPDR).

A reference circle RC1 is illustrated in a dashed-line format in FIG. 6B, which is centered at the center of rotation CN1, and includes the surface points PMIN1 and PMIN1′ on the calibration surface CS1 of the calibration object OB1. As indicated, a radial distance from the surface point PMAX1 to the reference circle RC1 may correspond to the minimum-to-maximum surface point distance DMINTOMAX1. Similarly, a radial distance from the surface point PMAX1′ to the reference circle RC1 may correspond to the minimum-to-maximum surface point distance DMINTOMAX1′ (e.g., for which the distance DMINTOMAX1′ may be approximately equal to the distance DMINTOMAX1 when the calibration object OB1 is approximately centered on the rotary stage 514).

As described herein, the measurement range R (e.g., which in some implementations may be approximately equal to a working range WR) of the optical pen 120 spans between a minimum measurement distance ZMIN and a maximum measurement distance ZMAX (e.g., as described with respect to FIGS. 1-4B). In various implementations, it may be desirable for the surface point distance range SPDR1 (e.g., as corresponding to a minimum-to-maximum surface point distance DMINTOMAX1) to be at least as large as the working range WR/measurement range R (e.g., and with the calibration object OB1 and/or optical pen 120 positioned such that the working range WR/measurement range R “falls within” the surface point distance range SPDR1, such as can occur when the working range WR/measurement range R is equal to or smaller than the surface point distance range SPDR1). In contrast, if the working range WR/measurement range R was larger than the surface point distance range SPDR1, then the collected calibration data may not cover the full working range WR/measurement range R, as will be described in more detail below.

FIG. 6C is a graph with a rotation angle versus measurement distance curve 610 that indicates Z-distances/Z-heights (i.e., in accordance with Z(φ) of the optical pen 120) at corresponding rotation angles of the calibration object OB1 (e.g., in accordance with the above noted equations). In the illustrated example, the curve 610 is shown to be approximately sinusoidal, and for which the shape of the curve 610 may be in accordance with the above equations (e.g., EQUATION 3 and/or 4). The illustrated curve 610 spans over a rotation range of the calibration object OB1 from 0 degrees to 360 degrees (i.e., corresponding to one full 360 degree rotation of the calibration object OB1). This is shown to correspond to two periods of the sinusoidal function of the curve 610 (i.e., for which a first period is between the measurements for the surface points PMAX1 and PMAX1′, and a second period is between the measurements for the surface points PMAX1′ and PMAX1, at the end of the full rotation). This is noted to correspond to the geometric characteristics of the calibration object OB1, which is an elliptical cylinder, which correspondingly has two surface points with maximum surface point distances on opposite sides of the calibration object, and two surface points with minimum surface point distances on opposite sides of the calibration object, resulting in two periods of the curve 610 over the full 360 degrees of rotation of the calibration object OB1.

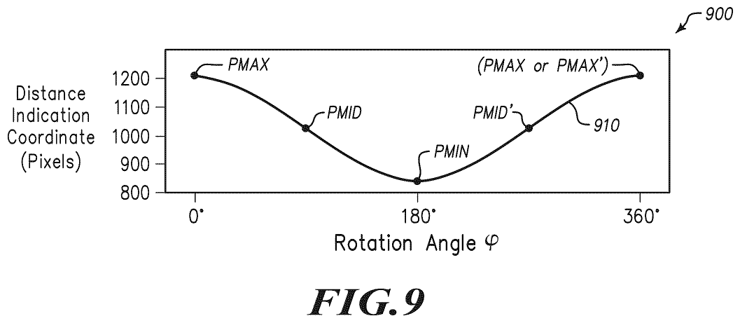

As will be described in more detail below, for the continuous curve 610 and/or a corresponding equation (e.g., EQUATION 3 and/or 4), the measurement distances at additional and/or alternative rotation angles (e.g., such as in between the illustrated example surface points PMAX, PMIN and PMID) may also be determined. For example, as part of a calibration process, the optical pen 120 may be utilized to determine/produce distance indicating coordinates for 100s or 1000s of surface points on a calibration object (e.g., the calibration object OB1), each with a corresponding rotation angle. Each rotation angle may be associated with a measurement distance (e.g., in accordance with a curve such as curve 610 and/or a corresponding equation such as EQUATION 3 or 4), for which the corresponding distance indicating coordinate which is associated with that rotation angle may also be associated with the measurement distance. Through such a process, distance calibration data for the chromatic range sensor system with the optical pen 120 may be determined (e.g., as will be described in more detail below with respect to FIGS. 9 and 10, etc.).

For the curve 610, as illustrated in FIG. 6C, certain example rotation angles of the calibration object OB1 are indicated for corresponding surface points on the calibration surface CS1 of the calibration object OB1 (e.g., as measured by the optical pen 120). For example, for the first period, the rotation angle of 0 degrees is shown to correspond to the measurement distance of the surface point PMAX1 (i.e., with a corresponding maximum surface point distance SPDMAX1), and the rotation angle of 90 degrees is shown to correspond to the measurement distance of the surface point PMIN1 (i.e., with a corresponding minimum surface point distance SPDMIN1). In various implementations, the surface point PMID1 (i.e., with a corresponding surface point distance SPDMID1) is close to half-way between the surface points PMAX1 and PMIN1 (but not exactly half-way), and the surface point PMID1′ (i.e., with a corresponding surface point distance SPDMID1′) is close to half-way between the surface points PMIN1 and PMAX1′ (but not exactly half-way).

For the second period, the rotation angle of 180 degrees is shown to correspond to the measurement distance of the surface point PMAX1′ (i.e., with a corresponding maximum surface point distance SPDMAX1′), and the rotation angle of 270 degrees is shown to correspond to the measurement distance of the surface point PMIN1 (i.e., with a corresponding minimum surface point distance SPDMIN1′). In various implementations, the surface point PMID1″ (i.e., with a corresponding surface point distance SPDMID1″) is close to half-way between the surface points PMAX1′ and PMIN1′ (but not exactly half-way), and the surface point PMID1″′ (i.e., with a corresponding surface point distance SPDMID1″′) is close to half-way between the surface points PMIN1′ and PMAX1 (but not exactly half-way). At the full rotation of the calibration object OB1, the rotation angle of 360 degrees is shown to correspond back to the measurement distance of the surface point PMAX1 (i.e., with the corresponding maximum surface point distance SPDMAX1).

A distance DMINTOMAX1 is shown to correspond to a difference between the maximum surface point distance SPDMAX1 and the minimum surface point distance SPDMIN1. A distance DMINTOMAX1′ is shown to correspond to a difference between the maximum surface point distance SPDMAX1′ and the minimum surface point distance SPDMIN1′. In implementations where the calibration object OB1 is formed according to precise desired specifications and is at least approximately centered on the rotary stage, the maximum surface point distances SPDMAX1 and SPDMAX1′ may be approximately equal, the mid surface point distances SPDMID1, SPDMID1′, SPDMID1″, and SPDMID1″′ may be approximately equal, the minimum surface point distances SPDMIN1 and SPDMIN1′ may be approximately equal, and the distances DMINTOMAX1 and DMINTOMAX1′ may be approximately equal.

The curve 610 illustrates how precise measurement distances from the optical pen 120 (e.g., based on known geometric characteristics of the calibration object OB1, such as in accordance with EQUATION 3 and/or 4) may be correlated with precise rotation angles of the calibration object OB1. As will be described in more detail below (e.g., with respect to FIG. 10), such data (e.g., as based on the known geometric characteristics of the calibration object OB1) may be utilized as part of the process for determining distance calibration data for the chromatic range sensor system (i.e., including the optical pen). More specifically, in various implementations as will be described in more detail below, a process may be performed (e.g., including rotation of the calibration object) to determine distance indicating data. As part of such a process, each measured surface point at a corresponding rotation angle of the calibration object OB1 is associated with a distance indicating coordinate (i.e., as determined/produced by the operation of the optical pen 120). Then, the determining of the distance calibration data comprises correlating the distance indicating coordinate for each measured surface point with the measurement distance from the optical pen 120 to the surface point (e.g., in accordance with the rotation angles and distances such as those of the curve 610 and/or in accordance with EQUATION 3 and/or 4, as based on known geometric characteristics of the calibration object OB1, etc.).

FIGS. 7A and 7B illustrate second and third implementations of calibration objects OB2A and OB2B, respectively. As illustrated in FIGS. 7A and 7B which show top views, the calibration objects OB2A and OB2B are each a combination of two portions of circular cylinders (e.g., which may be utilized as the cylindrical calibration object OB as shown in the side view of FIG. 5B, and as illustrated in FIG. 5A). In the top views of FIGS. 7A and 7B, the calibration objects OB2A and OB2B (e.g., and/or a corresponding horizontal cross-section thereof) are each shown to be in the shape of at least part of a smaller circle (i.e., of a smaller first cylindrical portion FCP2A and FCP2B, respectively) as combined with a portion of a larger circle (i.e., of a larger second cylindrical portion SCP2A and SCP2B, respectively).

The calibration objects OB2A and OB2B each also has a height “h” (e.g., not shown, which may be similar to the height as illustrated for the object OB in FIGS. 5A and 5B in some implementations, or any other height that enables the calibration object OB2A or OB2B to be measured by the measuring machine 510 and utilized for the calibration processes as described below). The calibration objects OB2A and OB2B are also each illustrated with a center of rotation CN2A and CN2B, respectively (e.g., as may correspond to a desired/positioned center of rotation when the calibration object OB2A or OB2B is positioned on the rotary stage 514 of the measuring machine 510 of FIGS. 5A and 5B). The centers of rotation CN2A and CN2B are shown to be at the centers of what would be the complete larger circles/cylinders of the second cylindrical portions SCP2A and SCP2B, respectively.

In various implementations, the calibration object OB2A may be fabricated by/correspond to starting with a relatively larger cylinder (e.g., as corresponding to the larger cylindrical portion SCP2A) and removing (e.g., by cutting, drilling, etc.) a section that is in the shape of at least part of the relatively smaller cylinder (e.g., as corresponding to the smaller cylindrical portion FCP2A which may then be inserted in the removed section so as to form the calibration object OB2A). In various implementations, the calibration object OB2B may be fabricated by/correspond to starting with a relatively larger cylinder (e.g., as corresponding to the larger cylindrical portion SCP2B) and removing a section with a flat cut (e.g., to form a circular segment), and also cutting a relatively smaller cylinder in half (e.g., as corresponding to the smaller cylindrical portion FCP2B) which may then be coupled/added together so as to form the calibration object OB2B. In various implementations, the starting cylinders of the calibration objects OB2A and OB2B (e.g., and/or other cylinders described herein, such as of the calibration object OB3 of FIGS. 8A-8C) may have precise well defined surfaces (e.g., for which in various implementations the starting cylinders may be gauge pins and/or other precisely formed cylinders).

As illustrated in FIGS. 7A and 7B, the centers of rotation CN2A and CN2B (i.e., in the second cylindrical portions SCP2A and SCP2B) are shown to be offset from points CNF2A and CNF2B (e.g., in the first cylindrical portions FCP2A and FCP2B) by an amount delta Δ_{2A} and delta Δ_{2B}, respectively (e.g., as each represented in an EQUATION 5 as delta Δ as described in more detail below). In the calibration object OB2A, the point CNF2A corresponds to the axial center of the circular cylinder of the first cylindrical portion FCP2A. In the calibration object OB2B, the point CNF2B corresponds to what would otherwise be the axial center of the smaller circular cylinder (e.g., before it was cut in two halves to form the first cylindrical portion FCP2B), and for which the point CNF2B is also correspondingly at a midpoint along the flat side of the first cylindrical portion FCP2B.

As described and represented in FIG. 6B, a measurement beam 196′ (i.e., of the optical pen 120) may be directed toward the side of the calibration object (e.g., with the measurement beam 196′ at the top of the FIG. 7A or FIG. 7B, but not shown in FIG. 7A or FIG. 7B for simplicity of the illustrations). At a start of a calibration process, the calibration object OB2A or OB2B may initially be positioned on the rotary stage (e.g., rotary stage 514) of the measuring machine, and may be centered or otherwise positioned (e.g., such that the center of rotation CN2A or CN2B of the calibration object OB2A or OB2B is aligned with an axis of rotation or otherwise at a center of rotation of the rotary stage). As part of a process for such positioning/centering, the calibration object OB2A or OB2B may initially be placed on the rotary stage, and then the rotary stage may be rotated (i.e., to correspondingly rotate the calibration object), and measurements may be taken (e.g., from the CRS system/optical pen or otherwise) of the calibration surface to determine if the calibration object is centered, and then if centering has not yet been achieved the position of the calibration object on the rotary stage may be further adjusted, and if needed the process may be repeated until an acceptable centering of the calibration object is achieved. It will be appreciated that if the center CN2A or CN2B is properly centered on the rotary stage, the measurements that indicate the distance to the calibration object OB2A or OB2B should not vary over the portion of the surface that corresponds to the outer surface (i.e., the outer circular surface) of the second cylindrical portion SCP2A or SCP2B.

In relation to such processes, it will be appreciated that the second cylindrical portion SCP2A or SCP2B provides an outer surface that can be utilized to align the calibration object OB2A or OB2B to be on center relative to the rotation axis of the rotary stage of the measuring machine. The second cylindrical portion SCP2A or SCP2B is also noted to be coupled to the first cylindrical portion FCP2A or FCP2B that is set at an offset delta Δ relative to the center of rotation CN2A or CN2B of the second cylindrical portion SCP2A or SCP2B, respectively.

A rotation angle of the rotary stage may correspond to a rotation angle of the calibration object OB2A or OB2B. In one example, the calibration object/rotary stage may be regarded as having a rotation angle of 0 degrees in a particular orientation (e.g., in an orientation where the surface point PMAX2A or PMAX2B is at a top, i.e., in a “12 o'clock position, of the calibration object OB2 in relation to the view of FIG. 7A or 7B). Thereafter, once rotation begins, the rotation angle φ may be in relation to the initial/0 degree orientation. For the calibration object OB2A or OB2B, as the rotation progresses, different surface points on the calibration surface CS2A or CS2B (i.e., primarily on the outer surface of the first cylindrical portion FCP2A or FCP2B) of the calibration object OB2A or OB2B will be at different distances from the optical pen 120 (i.e., as the surface points are rotated to be in front of the measurement beam 196′, such as aligned with the measurement axis MA′ at the center of the measurement beam 196′ as illustrated in FIG. 1).

In various implementations, a Z-distance/Z-height of a surface point may be expressed as a function of the rotation angle φ, for which the Z-distance/Z-height of a surface point may be expressed according to Z(φ). In various implementations, an equation that may be utilized to represent a relationship between the Z-distance/Z-height Z(φ) and the rotation angle φ of the calibration object OB2A or OB2B may be expressed as:

$$Z ( φ ) - {Z}_{offset} = Δ cos ( φ - {φ}_{offset} ) + \sqrt{{r}^{2} - {Δ}^{2} {sin}^{2} ( φ - {φ}_{offset} )} \qquad ( Eq . 5 )$$

where r is the radius of the first cylindrical portion FCP2A or FCP2B (i.e., represented in FIGS. 7A and 7B as a radius r_{2A} or a radius r_{2B}), φ is an angle of rotation, φ_{offset} is an offset angle, Z_{offset} is a value that can be varied to set a center of the CRS working range to correspond to a specific pixel position (e.g., for which the wavelength detector 162 with the detector array 163 includes the plurality of pixels with respective pixel positions distributed along a wavelength measurement axis of the wavelength detector).

In various implementations, the value of the delta Δ and the radius r for the calibration object OB2A or OB2B may be selected/designated (e.g., as part of the fabrication process for the calibration object or otherwise) to allow for a calibration of the CRS system with the optical pen 120, such that it may be desirable for the value of the distance DMINTOMAX2A or DMINTOMAX2B to be at least as large as the working range WR/measurement range R that is to be calibrated, as will be described in more detail below.

As part of such configurations and in relation to the above equation, as some illustrative examples, there may be one or more surface points that will be at a maximum surface point distance SPDMAX from the optical pen 120, and one or more surface points that will be at a minimum surface point distance SPDMIN from the optical pen 120. In relation to the illustrations of FIGS. 7A and 7B, the calibration surfaces CS2A and CS2B may correspondingly have surface points PMAX2A, PMAX2A′ or surface points PMAX2B, PMAX2B′, that will be at the maximum surface point distance, and a surface point PMIN2A or PMIN2B that will be at the minimum surface point distance (e.g., for which a line through the points PMIN2A and CNF2A may also run through the center of rotation CN2A, and a line through the points PMIN2B and CNF2B may also run through the center of rotation CN2B).

In various implementations, a surface point distance range SPDR may correspond to a difference between the maximum and minimum surface point distances (e.g., SPDR2A=SPDMAX2A−SPDMIN2A or SPDR2B=SPDMAX2B−SPDMIN2B). In various implementations, a surface point distance range SPDR2A or SPDR2B may be close to but not equal to a minimum-to-maximum surface point distance DMINTOMAX2A or DMINTOMAX2B (e.g., as illustrated in FIGS. 7A and 7B). A reference circle (i.e., as primarily surrounding the second cylindrical portions SCP2A and SCP2B) is illustrated in a dashed-line format in each of FIGS. 7A and 7B, which is centered at the centers of rotation CN2A and CN2B.

As described herein, the measurement range R (e.g., which in some implementations may be approximately equal to a working range WR) of the optical pen 120 spans between a minimum measurement distance ZMIN and a maximum measurement distance ZMAX (e.g., as described with respect to FIGS. 1-4B). In various implementations, it may be desirable for the surface point distance range SPDR2A or SPDR2B (e.g., as close to but not equal to a minimum-to-maximum surface point distance DMINTOMAX2A or DMINTOMAX2B) to be at least as large as the working range WR/measurement range R (e.g., and with the calibration object OB2A or OB2B and/or optical pen 120 positioned such that the working range WR/measurement range R “falls within” the surface point distance range SPDR2A or SPDR2B, such as can occur when the working range WR/measurement range R is equal to or smaller than the surface point distance range SPDR2A or SPDR2B). In contrast, if the working range WR/measurement range R was larger than the surface point distance range SPDR2A or SPDR2B, then the collected calibration data may not cover the full working range WR/measurement range R.

It will be appreciated that in various implementations, at least part of a graph with a rotation angle versus measurement distance curve (e.g., at least part of the graph of FIG. 6C and correspondingly at least part of the curve 610 and/or the graph of FIG. 8C and correspondingly the curve 810) may indicate Z-distances/Z-heights (i.e., in accordance with Z(φ) of the optical pen 120) at corresponding rotation angles of the calibration object OB2A or OB2B (e.g., in accordance with the above noted EQUATION 5). The corresponding curve may be approximately sinusoidal (e.g., similar to a portion of the curve 610 and/or the curve 810), and for which the shape of the curve may be in accordance with the above EQUATION 5. The curve may span over a smaller rotation range (e.g., as compared to the curve 610 and/or 810), in that a relatively smaller rotation range is required for moving the calibration surface CS2A or CS2B (i.e., as primarily corresponding to the outer surfaces of the first cylindrical portions FCP2A and FCP2B) to be measured by the optical pen 120.

For the calibration object OB2A, the curve may start at a maximum as corresponding to a surface point PMAX2A, then go to a minimum as corresponding to a surface point PMIN2A, and then go back up to a maximum as corresponding to a surface point PMAX2A′ (e.g., similar to the shape of the curve 810 of FIG. 8C). For the calibration object OB2B, the curve may start at a maximum as corresponding to a surface point PMAX2B, then go to a minimum as corresponding to a surface point PMIN2B, and then go back up to a maximum as corresponding to a surface point PMAX2B′ (e.g., similar to the shape of the curve 810 of FIG. 8C). This is noted to correspond to the geometric characteristics of the calibration object OB2A or OB2B.

As will be described in more detail below, in accordance with such a curve and/or a corresponding equation (e.g., EQUATION 5), the measurement distances at additional and/or alternative rotation angles (e.g., such as in between the example surface points PMAX2A and PMIN2A, or the example surface points PMAX2B and PMIN2B), may also be determined. For example, as part of a calibration process, the optical pen 120 may be utilized to determine/produce distance indicating coordinates for 100s or 1000s of surface points on a calibration object (e.g., the calibration object OB2A or OB2B), each with a corresponding rotation angle. Each rotation angle may be associated with a measurement distance (e.g., in accordance with a curve such as that described above and/or a corresponding equation such as EQUATION 5), for which the corresponding distance indicating coordinate which is associated with that rotation angle may also be associated with the measurement distance. Through such a process, distance calibration data for the chromatic range sensor system with the optical pen 120 may be determined (e.g., as will be described in more detail below with respect to FIGS. 9 and 10, etc.).

In various implementations, certain example surface points may be described/designated as corresponding to certain measurement distances from the optical pen 120. For example, for the calibration object OB2A, the surface point PMAX2A may be at a corresponding maximum surface point distance SPDMAX2A, the surface point PMIN2A may be at a corresponding minimum surface point distance SPDMIN2A, and the surface point PMAX2A′ may be at a corresponding maximum surface point distance SPDMAX2A′ (e.g., similar to the examples of the graphs of FIGS. 6C and 8C). Similarly, for the calibration object OB2B, the surface point PMAX2B may be at a corresponding maximum surface point distance SPDMAX2B, the surface point PMIN2B may be at a corresponding minimum surface point distance SPDMIN2B, and the surface point PMAX2B′ may be at a corresponding maximum surface point distance SPDMAX2B′ (e.g., similar to the examples of the graphs of FIGS. 6C and 8C).

Such examples indicate how precise measurement distances from the optical pen 120 (e.g., based on known geometric characteristics of the calibration object OB2A or OB2B, such as in accordance with EQUATION 5) may be correlated with precise rotation angles of the calibration object OB2A or OB2B. As will be described in more detail below (e.g., with respect to FIG. 10), such data (e.g., as based on the known geometric characteristics of the calibration object OB2A or OB2B) may be utilized as part of the process for determining distance calibration data for the chromatic range sensor system (i.e., including the optical pen). More specifically, in various implementations as will be described in more detail below, a process may be performed (e.g., including rotation of the calibration object) to determine distance indicating data. As part of such a process, each measured surface point at a corresponding rotation angle of the calibration object OB2A or OB2B is associated with a distance indicating coordinate (i.e., as determined/produced by the operation of the optical pen 120). Then, the determining of the distance calibration data comprises correlating the distance indicating coordinate for each measured surface point with the measurement distance from the optical pen 120 to the surface point (e.g., in accordance with the rotation angles and distances such as in accordance with EQUATION 5, as based on known geometric characteristics of the calibration object OB2A or OB2B, etc.).

FIGS. 8A-8C illustrate a fourth implementation of a calibration object OB3. As illustrated in FIG. 8A which shows a top view, the calibration object OB3 is a circular cylinder (e.g., which may be utilized as the cylindrical calibration object OB as shown in the side view of FIG. 5B, and as illustrated in FIG. 5A). In the top view of FIG. 8A, the calibration object OB3 (e.g., and/or a corresponding horizontal cross-section thereof) is shown to be in the shape of a circle. The calibration object OB3 also has a height “h” (e.g., not shown, which may be similar to the height as illustrated for the object OB in FIGS. 5A and 5B in some implementations, or any other height that enables the calibration object OB3 to be measured by the measuring machine 510 and utilized for the calibration processes as described below). The calibration object OB3 is also illustrated with a center of rotation CN3 (e.g., as may correspond to a desired/positioned center of rotation when the calibration object OB3 is positioned on the rotary stage 514 of the measuring machine 510 of FIGS. 5A and 5B). The center of rotation CN3 is shown to be offset from an actual center CNF3 of the circle, as will be described in more detail below.

As illustrated in FIG. 8B, which is also a top view, the center of rotation CN3 is shown to be offset from an actual center CNF3 of the circle by an amount delta Δ (e.g., as represented in an EQUATION 6 as described in more detail below). As described and represented in FIG. 6B, a measurement beam 196′ (i.e., of the optical pen 120) may be directed toward the side of the calibration object (e.g., with the measurement beam 196′ at the top of the figure, but not shown in FIG. 8B for simplicity of the illustration). At a start of a calibration process, the calibration object OB3 may initially be positioned on the rotary stage (e.g., rotary stage 514) of the measuring machine, and may be centered or otherwise positioned (e.g., such that the actual center CNF3 of the circle of the calibration object OB3 is aligned with an axis of rotation or otherwise at a center of rotation of the rotary stage). As part of a process for such positioning/centering, the calibration object OB3 may initially be placed on the rotary stage, and then the rotary stage may be rotated (i.e., to correspondingly rotate the calibration object), and measurements may be taken (e.g., from the CRS system/optical pen or otherwise) of the calibration surface to determine if the calibration object is centered, and then if centering has not yet been achieved the position of the calibration object on the rotary stage may be further adjusted, and if needed the process may be repeated until an acceptable centering of the calibration object is achieved.

It will be appreciated that if the center CNF3 is properly centered on the rotary stage, the measurements that indicate the distance to the calibration object OB3 should not vary as the calibration object OB3 is rotated. After such a centering process, the calibration object OB3 may then be moved on the rotary stage to be positioned/precisely shifted by the amount/distance delta Δ, so that the center of rotation CN3 of the calibration object OB3 is aligned with an axis of rotation or otherwise at a center of rotation of the rotary stage. In various implementations, the optical pen may be positioned/located in relation to the calibration object OB3 (e.g., in some implementations the position of the optical pen 120 may be adjusted after the calibration object OB3 has been positioned/centered on the rotary stage, so that the working range WR/measurement range R of the optical pen 120 falls within a surface point distance range SPDR3 of the calibration object OB3, as will be described in more detail below.

A rotation angle of the rotary stage may correspond to a rotation angle of the calibration object OB3. In one example, the calibration object/rotary stage may be regarded as having a rotation angle of 0 degrees in a particular orientation (e.g., in a orientation where the surface point PMIN3 is at a top of the calibration object OB3 in relation to the view of FIG. 8B). Thereafter, once rotation begins, the rotation angle φ may be in relation to the initial/0 degree orientation. For the calibration object OB3 (i.e., in the shape of a circular cylinder with the offset center of rotation CN3), as the rotation progresses, different surface points on the calibration surface CS3 of the calibration object OB3 will be at different distances from the optical pen 120 (i.e., as the surface points are rotated to be in front of the measurement beam 196′, such as aligned with the measurement axis MA′ at the center of the measurement beam 196′ as illustrated in FIG. 1). In various implementations, a Z-distance/Z-height of a surface point may be expressed as a function of the rotation angle φ, for which the Z-distance/Z-height of a surface point may be expressed according to Z(φ). In various implementations, an equation that may be utilized to represent a relationship between the Z-distance/Z-height Z(φ) and the rotation angle φ of the calibration object OB3 may be expressed as:

$$Z ( φ ) - {Z}_{offset} = Δ cos ( φ - {φ}_{offset} ) + \sqrt{{R}^{2} - {Δ}^{2} {sin}^{2} ( φ - {φ}_{offset} )} \qquad ( Eq . 6 )$$

where r is the radius of the circle, φ is an angle of rotation, φ_{offset} is an offset angle, Z_{offset} is a value that can be varied to set a center of the CRS working range to correspond to a specific pixel position (e.g., for which the wavelength detector 162 with the detector array 163 includes the plurality of pixels with respective pixel positions distributed along a wavelength measurement axis of the wavelength detector).

It will be appreciated that in various implementations where the working range WR is much smaller than the radius r of the circle (e.g., in a specific implementation where the radius r=20 mm and the working range WR=0.5 mm) the above EQUATION 6 may in some implementations be simplified to:

$$Z ( φ ) - {Z}_{offset} \approx Δcos ( φ - {φ}_{offset} ) + R \qquad ( Eq . 7 )$$

In various implementations, the value of the offset A for the calibration object OB3 may be selected to allow for a calibration of the CRS system with the optical pen 120 (e.g., such that it may be desirable for the value of 2Δ to be at least as large as the working range WR/measurement range R that is to be calibrated, as will be described in more detail below).

As part of such configurations and in relation to the above equations, as some illustrative examples, there may be one or more surface points that will be at a maximum surface point distance SPDMAX from the optical pen 120, and one or more surface points that will be at a minimum surface point distance SPDMIN from the optical pen 120, and one or more surface points that may be at a mid surface point distance SPDMID from the optical pen 120 (e.g., as will be described in more detail below with respect to FIG. 8C). In relation to the illustration of FIG. 8B, the calibration surface CS3 may correspondingly have a surface point PMAX3 that will be at the maximum surface point distance, and a surface point PMIN3 that will be at the minimum surface point distance (e.g., for which a line through the surface points PMAX3 and PMIN3 may also run through the center of rotation CN3 and the center point CNF3 in the orientation illustrated in FIG. 8B). The calibration surface CS3 may also correspondingly have surface points PMID3 and PMID3′ that will be at the surface point distances SPDMID3 and SPDMID3′ (e.g., in various implementations close to half-way between the maximum and minimum surface point distances, but not exactly half-way).

In various implementations, a surface point distance range SPDR may correspond to a difference between the maximum and minimum surface point distances (e.g., SPDR3=SPDMAX3−SPDMIN3). In various implementations, a surface point distance range SPDR3 may also or alternatively be referenced as a minimum-to-maximum surface point distance DMINTOMAX3. A reference circle RC3 is illustrated in a dashed-line format in FIG. 8B, which is centered at the center of rotation CN3, and in various implementations may include surface points PMID3 and PMID3′ on the calibration surface CS3 of the calibration object OB3 (e.g., in the orientation illustrated in FIG. 8B). As indicated, a radial distance from the surface point PMAX3 to the reference circle RC3 may correspond to a mid-to-maximum surface point distance DMIDTOMAX3 (e.g., in the orientation illustrated in FIG. 8B). Similarly, a radial distance from the surface point PMIN3 to the reference circle RC3 may correspond to the minimum-to-mid surface point distance DMINTOMID3 (e.g., in the orientation illustrated in FIG. 8B, and for which the distance DMIDTOMAX3 may be approximately equal to the distance DMINTOMID3 when the center of rotation CN3 of the calibration object OB3 is approximately centered on the rotary stage 514).

As described herein, the measurement range R (e.g., which in some implementations may be approximately equal to a working range WR) of the optical pen 120 spans between a minimum measurement distance ZMIN and a maximum measurement distance ZMAX (e.g., as described with respect to FIGS. 1-4B). In various implementations, it may be desirable for the surface point distance range SPDR3 (e.g., as corresponding to a minimum-to-maximum surface point distance DMINTOMAX3) to be at least as large as the working range WR/measurement range R (e.g., and with the calibration object OB3 and/or optical pen 120 positioned such that the working range WR/measurement range R “falls within” the surface point distance range SPDR3, such as can occur when the working range WR/measurement range R is equal to or smaller than the surface point distance range SPDR3). In contrast, if the working range WR/measurement range R was larger than the surface point distance range SPDR3, then the collected calibration data may not cover the full working range WR/measurement range R, as will be described in more detail below.

FIG. 8C is a graph with a rotation angle versus measurement distance curve 810 that indicates Z-distances/Z-heights (i.e., in accordance with Z(φ) of the optical pen 120) at corresponding rotation angles of the calibration object OB3 (e.g., in accordance with the above noted equations). In the illustrated example, the curve 810 is shown to be approximately sinusoidal, and for which the shape of the curve 810 may be in accordance with the above equations (e.g., EQUATION 6 and/or 7). The illustrated curve 810 spans over a rotation range of the calibration object OB3 from 0 degrees to 360 degrees (i.e., corresponding to one full 360 degree rotation of the calibration object OB3). This is shown to correspond to one period of the sinusoidal function of the curve 810 (e.g., which may be contrasted with the two periods of the curve 610). This is noted to correspond to the geometric characteristics of the calibration object OB3 (e.g., which is a circular cylinder) and the off-center position on the rotary stage (e.g., in accordance with the center of rotation CN3), which correspondingly has a surface point with a maximum surface point distance and a surface point with a minimum surface point distance on opposite sides of the calibration object.

As will be described in more detail below, for the continuous curve 810 and/or a corresponding equation (e.g., EQUATION 6 and/or 7), the measurement distances at additional and/or alternative rotation angles (e.g., such as in between the illustrated example surface points PMAX, PMIN and PMID) may also be determined. For example, as part of a calibration process, the optical pen 120 may be utilized to determine/produce distance indicating coordinates for 100s or 1000s of surface points on a calibration object (e.g., the calibration object OB3), each with a corresponding rotation angle. Each rotation angle may be associated with a measurement distance (e.g., in accordance with a curve such as curve 810 and/or a corresponding equation such as EQUATION 6 and/or 7), for which the corresponding distance indicating coordinate which is associated with that rotation angle may also be associated with the measurement distance. Through such a process, distance calibration data for the chromatic range sensor system with the optical pen 120 may be determined (e.g., as will be described in more detail below with respect to FIGS. 9 and 10, etc.).

For the curve 810, as illustrated in FIG. 8C, certain example rotation angles of the calibration object OB3 are indicated for corresponding surface points on the calibration surface CS3 of the calibration object OB3 (e.g., as measured by the optical pen 120). For example, the rotation angle of 0 degrees is shown to correspond to the measurement distance of the surface point PMAX3 (i.e., with a corresponding maximum surface point distance SPDMAX3), and the rotation angle of 180 degrees is shown to correspond to the measurement distance of the surface point PMIN3 (i.e., with a corresponding minimum surface point distance SPDMIN3). In various implementations, the surface point PMID3 (i.e., with a corresponding surface point distance SPDMID3) is close to half-way between the surface points PMAX3 and PMIN3 (but not exactly half-way), and the surface point PMID3′ (i.e., with a corresponding surface point distance SPDMID3′) is close to half-way between the surface points PMIN3 and PMAX3 (but not exactly half-way). At the full rotation of the calibration object OB3, the rotation angle of 360 degrees is shown to correspond back to the measurement distance of the surface point PMAX3 (i.e., with the corresponding maximum surface point distance SPDMAX3).

A distance DMIDTOMAX3 is shown to correspond to a difference between the maximum surface point distance SPDMAX3 and the mid surface point distance SPDMID3. A distance DMINTOMID3 is shown to correspond to a difference between the minimum surface point distance SPDMIN3 and the mid surface point distance SPDMID3. In some implementations where the calibration object OB3 is formed according to precise desired specifications and the center of rotation CN3 is at least approximately centered on the rotary stage, the distances DMIDTOMAX3 and DMINTOMID3 may be approximately equal, and a sum of the distances may be equal to a distance DMINTOMAX3.

The curve 810 illustrates how precise measurement distances from the optical pen 120 (e.g., based on known geometric characteristics and off-center positioning of the calibration object OB3, such as in accordance with EQUATION 6 and/or 7) may be correlated with precise rotation angles of the calibration object OB3. As will be described in more detail below (e.g., with respect to FIG. 10), such data (e.g., as based on the known geometric characteristics and off-center positioning of the calibration object OB3) may be utilized as part of the process for determining distance calibration data for the chromatic range sensor system (i.e., including the optical pen). More specifically, in various implementations as will be described in more detail below, a process may be performed (e.g., including rotation of the calibration object) to determine distance indicating data. As part of such a process, each measured surface point at a corresponding rotation angle of the calibration object OB3 is associated with a distance indicating coordinate (i.e., as determined/produced by the operation of the optical pen 120). Then, the determining of the distance calibration data comprises correlating the distance indicating coordinate for each measured surface point with the measurement distance from the optical pen 120 to the surface point (e.g., in accordance with the rotation angles and distances such as those of the curve 810 and/or in accordance with EQUATION 6 and/or 7, as based on known geometric characteristics and off-center positioning of the calibration object OB3, etc.).

With respect to the curves 610 and 810 of FIGS. 6C and 8C, it will be appreciated that in various implementations the curves may be shifted by the offset angle φ_{offset}. For example, if the calibration object OB1 is placed with its axes pointing at angles of 45/135 degrees instead of 0/90 degrees, the measured curve will be shifted by 45 degrees.

In various implementations, an initial step of a calibration process which includes centering the calibration object (e.g., on the rotary stage of the measuring machine) may be performed in different ways depending on the geometrical properties of the calibration object. In various implementations, as part of such a process, pixel positions (e.g., on the wavelength detector 162) may be determined/monitored (e.g., in relation to distance indicating coordinates and/or as otherwise related to produced wavelength peaks, etc.) In relation to the calibration object OB1, the pixel position dependence on the rotation angle may have a rotation symmetry (e.g., of π), wherein measurements of surface points on opposite sides (e.g., at 180 degree rotation points) of the calibration object may have identical pixel positions when the calibration object OB1 is centered (e.g., and may not have such symmetry when the calibration object OB1 is not centered). In relation to the calibration object OB2A or OB2B, the pixel positions may remain constant for the portion of the rotation corresponding to the outer surface of the second cylindrical portion SCP2A or SCP2B, when the calibration object OB2A or OB2B is centered. In relation to the calibration object OB3, the pixel positions may remain constant across all rotation angle values when the calibration object OB3 is initially centered (e.g., before the calibration object is subsequently moved to the offset-position). Each of these characteristics may be utilized for determining/verifying a proper/desired centering of a calibration object as part of a calibration process.

In various implementations, a number of surface points may be measured as part of a scan, for determining distance indicating data which corresponds to a distance between the chromatic range sensor optical pen 120 and each respective surface point on the calibration surface of the calibration object. In some implementations the number of surface points measured may be in the hundreds or thousands. As one simplified example, if average Z axis direction steps of approximately 10 microns are desired, and if the measurement range R/working range WR of an optical pen 120 is approximately 100 microns, such may correspond to measuring approximately 10 surface points (i.e., equal to 100/10) over the 100 micron range for determining the desired distance calibration data. As another example, if average Z axis direction steps of approximately 1.0 microns are desired, and if the measurement range R/working range WR of an optical pen 120 is approximately 100 microns, such may correspond to measuring approximately 100 surface points (i.e., equal to 100/1) over the 100 micron range for determining the desired distance calibration data (e.g., which may correspond to higher accuracy than the 10 micron step example). As another example, if average Z axis direction steps of approximately 0.3 microns are desired, with a measurement range R/working range WR for the optical pen 120 of approximately 300 microns, such may correspond to measuring approximately 1,000 surface points (i.e., equal to 300/0.3) over the 300 micron range for determining the desired distance calibration data.

As described above, the measurement range R of the optical pen 120 spans between a minimum measurement distance ZMIN and a maximum measurement distance ZMAX (e.g., as described with respect to FIGS. 1-4B). In accordance with the shape and/or off-center positioning of the calibration object (e.g., the calibration object OB1, OB2A, OB2B, or OB3), the surface points on the calibration surface may be at different distances from the optical pen 120 as the calibration object is rotated. As part of such configurations, there may be one or more surface points that will be at a maximum surface point distance SPDMAX, and one or more surface points that will be at a minimum surface point distance SPDMIN from the optical pen 120. A surface point distance range SPDR may correspond to a difference between the maximum and minimum surface point distances (e.g., SPDR=SPDMAX−SPDMIN).

In various implementations, it may be desirable for the surface point distance range SPDR to be at least as large as the working range WR (e.g., which in some implementations may be equal to the measurement range R). In implementations where the working range WR=ZMAX−ZMIN (e.g., with the working range WR approximately equal to the measurement range R), and the surface point distance range SPDR is at least as large as the working range WR, this may enable calibration data to be collected over the full working range of the optical pen 120 as the calibration object is rotated. In contrast, if the working range WR was larger than the surface point distance range SPDR, then the collected calibration data would not cover the full working range. In various implementations, it may be desirable for the optical pen 120 to be positioned relative to the calibration object such that the working range WR is appropriately centered relative to the surface point distance range of the calibration object (e.g., to help ensure that both ends of the working range WR fall within the surface point distance range SPDR and that calibration data is thereby obtained for the full working range as the calibration object is rotated). In an example where the surface point distance range SPDR is equal to the working range WR and the two ranges are perfectly aligned, the minimum surface point distance SPDMIN may be equal to the minimum range distance ZMIN, and the maximum surface point distance SPDMAX may be equal to the maximum range distance ZMAX.

In general, a chromatic range sensor system as including an optical pen 120 requires a determination of distance calibration data before it can be utilized. Such a calibration process may consist of correlating measurement distances with distance indicating coordinates (e.g., for which the distance indicating coordinates may be in terms of pixel coordinates and for which the wavelength detector 162 with the detector array 163 includes the plurality of pixels with respective pixel positions distributed along a wavelength measurement axis of the wavelength detector). As part of the process, a distance between the optical pen 120 and a calibration surface is varied, for which different distance indicating coordinates are produced as corresponding to the different distances (e.g., as described in more detail below with respect to FIG. 9).

As described herein, the varying of the distance (i.e., and the corresponding determination of different distance indicating coordinates as corresponding to the different distances) is achieved by rotating a calibration object (e.g., for which variances in the distances may be due to at least one of: a shape of the calibration object; or an off-center positioning of the calibration object on a rotary stage of the measuring machine). The variance in the distances may depend on a rotation angle φ of the calibration object (e.g., a distance Z(φ) may be defined by an equation, such as one of the EQUATIONS 3-7 as described herein). The accurately measured rotation angle φ (e.g., as measured by a sensor such as a rotary encoder of the measuring machine, such as rotary encoder 527, when a distance indicating coordinate is determined) may then be utilized for accurately determining a measurement distance Z(φ) as corresponding to the rotation angle φ and the corresponding distance indicating coordinate (e.g., as will be described in more detail below with respect to FIG. 10).

FIG. 9 is a diagram 900 illustrating a distance indicating coordinate versus rotation angle curve 910. As described herein, in various implementations the scan (e.g., as performed as part of the calibration process) may include collecting peak position data (e.g., as corresponding to distance indicating coordinates) as a function of the rotation angle of the calibration object as the calibration object is rotated. More specifically, as part of the scan, for each surface point that is measured at a corresponding rotation angle of the calibration object, a distance indicating coordinate is determined for the surface point (e.g., based on a wavelength peak that results along a wavelength measurement axis from the measurement of the surface point, wherein the wavelength measurement axis is of a detector array of a wavelength detector of the chromatic range sensor system, as described above with respect to FIGS. 1-4B).

With respect to the curve 910, while for simplicity of the illustration only a relatively few surface points are labeled/illustrated in the example (e.g., surface points PMAX, PMID, PMIN, PMID′, etc.), in various implementations a greater number of surface points (e.g., 100s or 1000s of surface points) may be measured as part of a scan for determining the distance calibration data (e.g., as including the distance indicating coordinates). In various implementations, the shape of the curve 910 may be noted to be similar to the shapes of at least parts of the curves 610 and 810 of FIGS. 6C and 8C (e.g., for which as noted above the curves 610 and 810 indicate distances to surface points at corresponding rotation angles of the calibration object, and for which increases and decreases in the distances may generally correspond to increases and decreases in distance indicating coordinates along a wavelength measurement axis).

In relation to the implementations with the different calibration objects as illustrated in FIGS. 6A-6C (i.e., calibration object OB1), FIGS. 7A and 7B (i.e., calibration objects OB2A and OB2B), and FIGS. 8A-8C (i.e., calibration object OB3), it is noted that the range of the representative curve 910 (i.e., as representative of the distance indicating coordinates vs. rotation angles for a given calibration object) may vary. As an example, for the calibration object of FIGS. 8A-8C (i.e., calibration object OB3), in various implementations the range of the curve 910 may be from 0 degrees to 360 degrees. This would be with the illustrated surface points PMAX, PMIN and PMAX of the curve 910 corresponding to rotation angles of 0 degrees, 180 degrees, and 360 degrees, respectively (e.g., as corresponding to the surface points PMAX3, PMIN3 and PMAX3, respectively, on the calibration object OB3). It is noted that the illustrated example values along the x-axis of FIG. 9 (e.g., of 0 degrees, 180 degrees, and 360 degrees) are consistent with this example (i.e., for the calibration object OB3).

For the calibration object of FIGS. 6A-6C (i.e., calibration object OB1), in various implementations the range of the curve 910 (or a similar curve) may be from 0 degrees to 180 degrees (e.g., for which the values of 180 degrees and 360 degrees as shown on the x-axis of FIG. 9 would be replaced with values of 90 degrees and 180 degrees, respectively, in such an example). This would be with the illustrated surface points PMAX, PMIN and PMAX′ of the curve 910 corresponding to rotation angles of 0 degrees, 90 degrees, and 180 degrees, respectively (e.g., as corresponding to the surface points PMAX1, PMIN1 and PMAX1′, respectively, on the calibration object OB1).

For the calibration objects of FIGS. 7A and 7B (i.e., calibration objects OB2A and OB2B), the range of the curve 910 (or a similar curve) may be from 0 degrees to a relatively smaller rotation angle (e.g., for which the values of 180 degrees and 360 degrees as shown on the x-axis of FIG. 9 would be replaced with values of correspondingly smaller angles, in such examples). This would be in accordance with the relatively smaller rotation angle required for the scan to move over the calibration surfaces in the calibration parts of the calibration objects OB2A and OB2B, such as primarily corresponding to the surfaces of the relatively smaller first cylindrical portions FCP2A and FCP2B. This would be with the surface points PMAX, PMIN and PMAX′ of the curve 910 corresponding to the surface points PMAX2A, PMIN2A and PMAX2A′, respectively (i.e., on the calibration object OB2A), or the surface points PMAX2B, PMIN2B and PMAX2B′, respectively (i.e., on the calibration object OB2B).

In each of the examples (e.g., for the calibration objects OB1, OB2A, OB2B and OB3), the surface point PMID may correspond to a rotation angle between the rotation angles corresponding to PMAX and PMIN. The surface point PMID′ may correspond to a rotation angle between the rotation angles corresponding to PMIN and either PMAX (e.g., for calibration object OB3, such as in relation to surface point PMAX3) or PMAX′ (e.g., for calibration objects OB1, OB2A and OB2B, such as in relation to surface points PMAX1′, PMAX2A′ and PMAX2B′, respectively).

It will be appreciated that these example ranges are for purposes of illustration only, and that an actual range of a curve such as the curve 910 may be relatively longer or shorter, depending on the desired amount of data (e.g., including distance indicating coordinates vs. rotation angles) to be collected for the calibration process (e.g., as may be collected during a partial rotation of a calibration object, or a full rotation, or multiple rotations, etc.). In addition, while such example values in relation to FIG. 9 are provided for simplicity of the explanation, it will be appreciated that other known types of similar calculations/techniques (e.g., which in some implementations may also include curve fitting, such as minimizing a fit error for a curve and/or interpolation or other techniques) may be utilized for determining the rotation angles of the calibration object and/or distance indicating coordinates and/or distances of the measured surface points based at least in part on the distance indicating data that is acquired during the scan, given the known properties/characteristics of the scan and the calibration surface, etc.

FIG. 10 is a diagram 1000 of a representation of CRS distance calibration data 1010 in the form of a distance calibration data curve, similar to that of FIG. 4A, which correlates distance indicating coordinates with measurement distances to a surface. The conversion of the curve 910 of FIG. 9 to the curve 1010 of FIG. 10 may include a conversion of the rotation angles of FIG. 9 to Z positions/distances of FIG. 10. In various implementations, such conversions may be done in accordance with known geometric characteristics/principles, for which a given rotation angle of the calibration object will result in a known corresponding Z position/distance for each surface point (e.g., in accordance with the known geometric and trigonometric relationships and characteristics, etc.)

FIG. 10 is noted to convey similar information as the calibration curve 410A of FIG. 4A, and may be utilized similarly to FIG. 4A as described above. In various implementations, when distance calibration data such as that illustrated by FIG. 10 is determined in accordance with principles as described herein, such determined distance calibration data may be utilized for various purposes. For example, for an optical pen that has not previously had distance calibration data determined, or for which existing distance calibration data is to be replaced, the distance calibration data illustrated by FIG. 10 may be stored in the calibration portion 169 of the memory portion 168 of the electronics portion 160.

Alternatively, in an implementation where distance calibration data such as that of FIG. 10 is utilized to perform an accuracy check on the stored distance calibration data of an optical pen, a comparison may be made between the distance calibration data of FIG. 10 and the previously stored distance calibration data, to determine if there are significant differences. In various implementations, if significant differences are found, a warning may be provided to a user that indicates that the stored distance calibration data may have inaccuracies, for which further action may be needed (e.g., such as further testing/verification and/or sending the optical pen 120 back to a factory or other facility for a full factory calibration to be performed, etc.) As noted above, with respect to the general nature of the calibration object OB (e.g., as corresponding to the calibration objects OB1, OB2A, OB2B, and OB3), it is expected to have a highly accurate calibration surface, as corresponding to the known/determined Z position/distance for each surface point for the given rotation angle of the calibration object (e.g., in accordance with the known geometric and trigonometric relationships and characteristics, etc.).

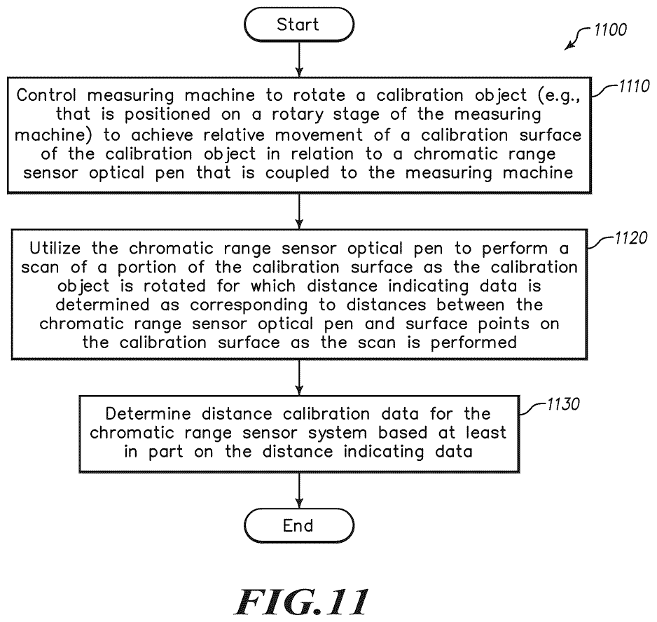

FIG. 11 is a flow diagram illustrating one exemplary embodiment of a routine 1100 for determining distance calibration data for a chromatic range sensor system (e.g., by taking measurements of surface points of a calibration object). The routine 1100 may be employed, for example, by one or more of the embodiments of a chromatic range sensor system described herein. The chromatic range sensor system has a chromatic range sensor optical pen 120 that is coupled to a measuring machine with a machine coordinate system. The chromatic range sensor optical pen 120 is configured to focus different wavelengths at different distances along a distance measurement axis proximate to a surface to be measured.

The routine 1100 begins at a block 1110, where the measuring machine is controlled to rotate the calibration object (e.g., that is positioned on the rotary stage of the measuring machine) to achieve relative movement of the calibration surface of the calibration object in relation to the chromatic range sensor optical pen that is coupled to the measuring machine. In various implementations, as part of an initial positioning of the calibration object on the rotary stage, the calibration object may be centered and/or moved to an off-center position. For example, in the implementations of FIGS. 6A-6C and 7A-7B, a rotation center point of a calibration object (e.g., rotation center point CN1, CN2A or CN2B) may be centered on the rotary stage of the measuring machine. In various implementations, such centering may include initially placing the calibration object on the rotary stage, and then rotating the calibration object to determine if measurements (e.g., from the CRS system/optical pen or otherwise) indicate that the calibration object is centered, and then if centering has not yet been achieved further adjusting the position of the calibration object on the rotary stage, and if needed repeating the process until an acceptable centering of the calibration object is achieved.

In relation to such a process, it is noted that when the calibration object OB1 is properly centered, that an expected symmetry of measurements to surface points on the calibration object may be achieved (e.g., measurement distances SPDMAX1 and SPDMAX1′ may be approximately equal, measurement distances SPDMIN1 and SPDMIN1′ may be approximately equal, etc.) Similarly, when one of the calibration objects OB2A or OB2B is properly centered on the rotary stage, an expected symmetry of measurements to surface points on the calibration object may be achieved (e.g., measurement distances SPDMAX2A and SPDMAX2A′ may be approximately equal, measurement distances SPDMAX2B and SPDMAX2B′ may be approximately equal and/or measurement distances to surface points spaced around the larger second cylinder portions SCP2A or SCP2B may be approximately equal, etc.).

In various implementations, the calibration object OB3 may also initially be positioned to be centered on the rotary stage (e.g., before being further moved/positioned/shifted to be at an off-center location/position on the rotary stage). During such an initial centering (e.g., where the point CNF3 is centered on the rotary stage), an expected symmetry of measurements to surface points on the calibration object may be achieved (e.g., given the circular nature of the calibration object OB3, there may be approximately no change in the measurement distances/all of the measurement distances may be approximately the same during the rotation of the calibration object). As noted above, after such an initial centering, the calibration object OB3 may be further moved/positioned/shifted (e.g., utilizing controls of the measuring machine or otherwise) to be at an off-center location/position on the rotary stage (e.g., where the center of rotation CN3 is centered on the rotary stage).

As illustrated in FIG. 11, at a block 1120, the chromatic range sensor optical pen is utilized to perform a scan of a portion of the calibration surface as the calibration object is rotated for which distance indicating data is determined as corresponding to distances between the chromatic range sensor optical pen and surface points on the calibration surface as the scan is performed. In various implementations, the relative movement of the calibration surface (e.g., as the calibration object is rotated by the measuring machine) results in the chromatic range sensor optical pen (e.g., as utilized by the system or otherwise) performing the scan. As described herein, in various implementations the scan may include collecting peak position data (e.g., as corresponding to distance indicating coordinates) as a function of the rotation angle of the calibration object as the calibration object is rotated. As described herein, the distance indicating data may be obtained, which may indicate Z distances/measurement distances as corresponding to peak locations. As discussed above, the surface points for which the distance indicating data is determined may number in the hundreds or thousands, and may comprise, for example at least 100 surface points.

At a block 1130, distance calibration data is determined for the chromatic range sensor system based at least in part on the distance indicating data. As described herein, in various implementations the determining of the distance calibration data may include calculating the distance calibration data (e.g., to be stored, such as to be included in a stored calibration table) at least in part by converting the recorded rotation angles of the calibration object to expected measurement distances (e.g., as based at least in part on the known geometry of the calibration object, etc.).

For example, in various implementations a known difference between the coordinates of surface points on the calibration surface and/or other known geometric characteristics of the calibration surface may correspond to at least part of a measurement distance from the optical pen to a surface point. For each surface point, the distance indicating data comprises a distance indicating coordinate that is determined for the surface point based on a wavelength peak that results along the wavelength measurement axis of the detector array 163 of the wavelength detector 162 from the measurement of the surface point. The determining of the distance calibration data may include correlating the distance indicating coordinate for each surface point with a distance corresponding to the measurement distance from the optical pen to the surface point. In various implementations, the distance calibration data may take the form of a calibration curve, such as the curve illustrated in FIG. 10.

Embodiments of a routine for determining distance calibration data for a chromatic range sensor system by taking measurements of surface points of a calibration object may perform additional acts not shown in FIG. 11, may perform fewer acts than shown in FIG. 11, may combine or separate acts shown in FIG. 11, and may perform acts in various orders.

For example, the routine 1100 may include an act of storing or uploading the distance calibration data. For example, the distance calibration data may be uploaded to the calibration portion 169 of the electronics portion 160 of the CRS system as illustrated in FIG. 1. The stored or uploaded distance calibration data may be utilized during a subsequent measurement of a surface point. A distance indicating coordinate for the surface point may be determined based on a wavelength peak that results along the wavelength measurement axis of the detector array from the measurement of the surface point, with the stored distance calibration data utilized to determine a measurement distance (e.g., from the optical pen to the measured surface point) based on a measurement distance that is correlated with the determined distance indicating coordinate by the stored distance calibration data.

In some embodiments, intensity peak data may be utilized in addition to the distance indicating data. For each measurement distance in the working range of the optical pen (e.g., as described with respect to FIGS. 3-4B), there may actually be a different total amount of light received by the optical pen 120 as part of its normal operations. More specifically, with reference to FIG. 3, the top of the wavelength peak 302 is shown to be at a level (e.g., a signal level of 0.93), due to the amount of light that is received for a surface point being measured at that distance. In comparison, as the optical pen is moved closer or further away from the surface, and the wavelength peak 302 moves to the left or right along the wavelength measurement axis that is illustrated in FIG. 3, the signal level (amount of illumination) for the different peaks may be higher or lower, depending on the amount of light that is actually received, for which the variances are part of the normal operations of the optical pen 120 and the light source, etc. (e.g., for which the light source may have a different amount of power that is provided for different light colors/light wavelengths along the range, etc.). Such signal level differences may affect the centroid calculations, etc., for determining the distance indicating coordinates, for which it may be desirable to compensate for such differences. In some implementations, it may be desirable to have two calibration data curves, such as FIG. 4A for distance calibration data for indicating distance indicating coordinates versus Z-height measurements, and a second curve for indicating how much illumination (e.g., signal level in FIG. 3) results at each measurement distance.

For example, prior to or after performing a calibration scan, in various implementations the relative position of the optical pen 120 may be moved closer to or further from the calibration object OB, such that only the distance Z from the optical pen 120 to the calibration object OB is changed. For example, a sweep may be performed (e.g., with the measurement beam 196′ directed at a specific surface point on the calibration surface) through a range of Z distances and intensity peak data as generated during the sweep. An intensity versus peak pixel curve may be determined based on the intensity peak data. More specifically, with reference to FIG. 3, as the optical pen 120 is moved to different distances from the calibration object OB, for each distance Z, the peak pixel coordinate (PPC) will be at a different location on the wavelength measurement axis, and for which the intensity (the signal level) is recorded for each peak pixel coordinate location. Such intensity peak data may be utilized for intensity normalization (e.g., as illustrated in FIG. 3 for which the signal level is indicated to be in normalized volts).

Alternatively, in some implementations intensity peak data may be gathered or approximated during the process of gathering the distance indicating data. For example, data from a scan may be employed to determine an approximation of an intensity normalization curve. More specifically, similar to the process described above where the calibration object is rotated to obtain different intensity normalization calibration data points, the heights of the peaks determined during the scan will generally each correspond to a different distance Z between the optical pen 120 and the respective surface point on the calibration object OB, for which the intensity (signal level) for each Z-height and corresponding peak pixel coordinate may be recorded as part of an intensity normalization curve.

After such intensity peak data is collected (e.g., before, after, or during the scan process), intensity calibration may be applied to the collected peaks from the scan, before the distance indicating coordinates are determined. In certain implementations, an intensity normalization calibration curve may not be collected. It is noted that the collection of the intensity normalization curve and its application to normalize the intensity (signal level) values in the measurement profile signals may in certain implementations result in more accurate distance calibration data and/or subsequent corresponding measurements.

In various implementations, the calibration process as described may be performed periodically (e.g., for determining new or updated calibration data for the CRS system, or for verifying the accuracy of the current calibration data stored in the CRS system, etc.). In various implementations, the calibration data determined from the calibration process may be stored in the calibration portion 169 of the CRS system 100 (e.g., as new calibration data, and/or to replace existing calibration data). If a difference is determined between the determined calibration data and existing calibration data, a warning/recommendation, etc. may be provided to a user (e.g., indicating that there may be an issue with the current stored calibration data, for which the new calibration data may be utilized, or the CRS system 100 may be returned to a factory or other facility for factory calibration, or other corrective process may be performed, etc.).

As described above, a method is provided for providing distance calibration data for a chromatic range sensor system with a chromatic range sensor optical pen that is coupled to a measuring machine. The chromatic range sensor optical pen is configured to focus different wavelengths at different distances proximate to a surface to be measured. The measuring machine is controlled to rotate a calibration object (e.g., that is positioned on a rotary stage of the measuring machine) to achieve relative movement of a calibration surface of the calibration object in relation to the chromatic range sensor optical pen. The chromatic range sensor optical pen is utilized to perform a scan of a portion of the calibration surface as the calibration object is rotated for which distance indicating data is determined as corresponding to distances between the chromatic range sensor optical pen and surface points on the calibration surface as the scan is performed. Distance calibration data for the chromatic range sensor system is determined based at least in part on the distance indicating data.

In some implementations, for each surface point, the distance indicating data includes a distance indicating coordinate that is determined for the surface point based on a wavelength peak that results along a wavelength measurement axis from the measurement of the surface point. In some implementations, the wavelength measurement axis is of a detector array of a wavelength detector of the chromatic range sensor system. The determining of the distance calibration data includes correlating the distance indicating coordinate for each surface point with the measurement distance from the chromatic range sensor optical pen to the surface point. In some implementations, for the performance of the scan, the surface points for which the distance indicating data is determined include at least 100 surface points.

In some implementations, for each surface point, a rotation angle of the calibration object is determined. In some implementations, for each surface point, the measurement distance from the chromatic range sensor optical pen to the surface point is determined based at least in part on the rotation angle of the calibration object and known geometric properties of the calibration surface. In some implementations, as at least part of the known geometric properties of the calibration surface, a cross-section of the calibration surface is at least partially elliptical or circular (e.g., as may relate/correspond to a sinusoidal function which indicates distances to surface points as the calibration object is rotated).

In some implementations, the distance calibration data is stored. As part of a subsequent measurement of a surface point, a distance indicating coordinate is determined for the surface point based on a wavelength peak that results along the wavelength measurement axis from the measurement of the surface point. The stored distance calibration data is utilized to determine a measurement distance from the chromatic range sensor optical pen to the measured surface point based on a measurement distance that is correlated with the determined distance indicating coordinate by the stored distance calibration data.

In some implementations, the chromatic range sensor optical pen has a measurement range extending between a minimum measurement distance and a maximum measurement distance. During the scan, surface points on the calibration surface are at different distances from the optical pen as the calibration object is rotated, for which there are one or more surface points that are at a maximum surface point distance from the optical pen, and one or more surface points that are at a minimum surface point distance from the optical pen. A surface point distance range corresponds to a difference between the maximum surface point distance and the minimum surface point distance. The chromatic range sensor optical pen is positioned so that the measurement range falls within the surface point distance range (e.g., for which in various implementations the surface point distance range may be approximately equal to or larger than the measurement range).

In some implementations, the method includes at least one of: centering the calibration object on a rotary stage of the measuring machine before the scan is performed; or moving the calibration object to an off-center position on a rotary stage of the measuring machine before the scan is performed. In some implementations, the calibration object is configured such that the distances between the chromatic range sensor optical pen and the surface points on the calibration surface vary as the scan is performed, for which the variances in the distances are due to at least one of: the shape of the calibration object; or an off-center positioning of the calibration object on a rotary stage of the measuring machine. In some implementations, the distances between the chromatic range sensor optical pen and the surface points on the calibration surface vary at least approximately in accordance with a sinusoidal function as the scan is performed.

In some implementations, the method includes determining intensity peak data as corresponding to an amount of light received by the chromatic range sensor optical pen for different distances between the chromatic range sensor optical pen and the calibration surface. Intensity calibration data is determined based on the intensity peak data, wherein the distance indicating data may be determined based at least in part on the intensity calibration data. In some implementations, the determining intensity peak data includes achieving relative movement of the chromatic range sensor optical pen for performing a sweep through a range of Z axis distances from the calibration surface, and capturing intensity peak data during the sweep. Determining the intensity calibration data includes generating an intensity normalization calibration curve based on the captured intensity peak data. In some implementations, the determining intensity peak data includes capturing intensity peak data during the scan. Determining intensity calibration data includes generating an intensity normalization calibration curve based on the captured intensity peak data.

In some implementations, a system is provided which includes a measuring machine, a chromatic range sensor system and a calibration object. The measuring machine includes a motion controller. The system is configured to utilize the motion controller to rotate the calibration object to achieve relative movement of the calibration surface in relation to the chromatic range sensor optical pen as a scan is performed by the chromatic range sensor optical pen, for which distance indicating data is determined as corresponding to distances between the chromatic range sensor optical pen and surface points on the calibration surface as the scan is performed. The distance indicating data is utilized to determine distance calibration data for the chromatic range sensor system.

In some implementations, the system is further configured to store the distance calibration data, and to subsequently perform a measurement process for determining a measurement distance which corresponds to a distance between the chromatic range sensor optical pen and a surface point on a surface. The measurement process includes determining a distance indicating coordinate for the surface point based on a wavelength peak that results along a wavelength measurement axis from the measurement of the surface point. The stored distance calibration data is utilized to correlate the distance indicating coordinate with the corresponding measurement distance.

In some implementations, the distance indicating data that corresponds to the distances between the chromatic range sensor optical pen and each surface point comprises a distance indicating coordinate that is determined for each surface point based on a wavelength peak that results along a wavelength measurement axis from the measurement of the surface point.

In some implementations, a chromatic range sensor system for use with a measuring machine and a calibration object having a calibration surface is provided. In some implementations, the chromatic range sensor system includes a chromatic range sensor optical pen, an illumination source, a wavelength detector, and a processing portion. The illumination source is configured to generate multi-wavelength input light having an input spectral profile that is input to the chromatic range sensor optical pen. The wavelength detector includes a plurality of pixels with respective pixel positions distributed along a wavelength measurement axis of the wavelength detector. The chromatic range sensor system is configured such that, when the chromatic range sensor optical pen is operably positioned relative to a surface to perform measurement operations, the chromatic range sensor optical pen inputs the input spectral profile and outputs corresponding radiation to the surface and receives reflected radiation from the surface and outputs the reflected radiation to the wavelength detector. The processing portion is configured to determine distance indicating data resulting from rotation of the calibration object by the measuring machine to achieve relative movement of the calibration surface in relation to the chromatic range sensor optical pen. The relative movement of the calibration surface results in the chromatic range sensor optical pen performing a scan of a portion of the calibration surface, from which the distance indicating data is determined as corresponding to distances between the chromatic range sensor optical pen and surface points on the calibration surface as the scan is performed. The distance calibration data is determined based at least in part on the distance indicating data. In some implementations, the distance calibration data correlates distance-indicating coordinates with measurement distances.

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein. In addition, the various implementations described above can be combined to provide further implementations. All of the U.S. patents and U.S. patent applications referred to in this specification are incorporated herein by reference, in their entirety. Aspects of the implementations can be modified, if necessary, to employ concepts of the various patents and applications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A method for providing distance calibration data for a chromatic range sensor system with a chromatic range sensor optical pen that is coupled to a measuring machine, wherein the chromatic range sensor optical pen is configured to focus different wavelengths at different distances proximate to a surface to be measured, the method comprising:
controlling the measuring machine to rotate a calibration object to achieve relative movement of a calibration surface of the calibration object in relation to the chromatic range sensor optical pen;
utilizing the chromatic range sensor optical pen to perform a scan of a portion of the calibration surface as the calibration object is rotated for which distance indicating data is determined as corresponding to distances between the chromatic range sensor optical pen and surface points on the calibration surface as the scan is performed; and
determining distance calibration data for the chromatic range sensor system based at least in part on the distance indicating data.

2. The method of claim 1, wherein for each surface point, the distance indicating data comprises a distance indicating coordinate that is determined for the surface point based on a wavelength peak that results along a wavelength measurement axis from the measurement of the surface point, and for which the determining of the distance calibration data comprises correlating the distance indicating coordinate for each surface point with the measurement distance from the chromatic range sensor optical pen to the surface point.

3. The method of claim 2, wherein the wavelength measurement axis is of a detector array of a wavelength detector of the chromatic range sensor system.

4. The method of claim 2, wherein for each surface point, a rotation angle of the calibration object is determined.

5. The method of claim 4, wherein for each surface point, the measurement distance from the chromatic range sensor optical pen to the surface point is determined based at least in part on the rotation angle of the calibration object and known geometric properties of the calibration surface.

6. The method of claim 5, wherein as at least part of the known geometric properties of the calibration surface, a cross-section of the calibration surface is at least partially elliptical or circular.

7. The method of claim 2, further comprising storing the distance calibration data, for which as part of a subsequent measurement of a surface point, a distance indicating coordinate is determined for the surface point based on a wavelength peak that results along the wavelength measurement axis from the measurement of the surface point, and the stored distance calibration data is utilized to determine a measurement distance from the chromatic range sensor optical pen to the measured surface point based on a measurement distance that is correlated with the determined distance indicating coordinate by the stored distance calibration data.

8. The method of claim 1, wherein:
the chromatic range sensor optical pen has a measurement range extending between a minimum measurement distance and a maximum measurement distance;
during the scan, surface points on the calibration surface are at different distances from the optical pen as the calibration object is rotated, for which there are one or more surface points that are at a maximum surface point distance from the optical pen, and one or more surface points that are at a minimum surface point distance from the optical pen, and a surface point distance range corresponds to a difference between the maximum surface point distance and the minimum surface point distance; and
the chromatic range sensor optical pen is positioned in relation to the calibration object so that the measurement range falls within the surface point distance range.

9. The method of claim 1, wherein for the performance of the scan, the surface points for which the distance indicating data is determined comprise at least 100 surface points.

10. The method of claim 1, further comprising at least one of:
centering the calibration object on a rotary stage of the measuring machine before the scan is performed; or
moving the calibration object to an off-center position on a rotary stage of the measuring machine before the scan is performed.

11. The method of claim 1, wherein the calibration object is configured such that the distances between the chromatic range sensor optical pen and the surface points on the calibration surface vary as the scan is performed, for which the variances in the distances are due to at least one of:
the shape of the calibration object; or
an off-center positioning of the calibration object on a rotary stage of the measuring machine.

12. The method of claim 1, wherein the distances between the chromatic range sensor optical pen and the surface points on the calibration surface vary at least approximately in accordance with a sinusoidal function as the scan is performed.

13. The method of claim 1, further comprising:
determining intensity peak data as corresponding to an amount of light received by the chromatic range sensor optical pen for different distances between the chromatic range sensor optical pen and the calibration surface; and
determining intensity calibration data based on the intensity peak data, wherein the distance indicating data is determined based at least in part on the intensity calibration data.

14. The method of claim 13, wherein:
the determining intensity peak data comprises achieving relative movement of the chromatic range sensor optical pen for performing a sweep through a range of Z axis distances from the calibration surface, and capturing intensity peak data during the sweep; and
the determining intensity calibration data comprises generating an intensity normalization calibration curve based on the captured intensity peak data.

15. The method of claim 13, wherein:
the determining intensity peak data comprises capturing intensity peak data during the scan; and
the determining intensity calibration data comprises generating an intensity normalization calibration curve based on the captured intensity peak data.

16. A system, comprising:
a measuring machine comprising a motion controller;
a chromatic range sensor system comprising a chromatic range sensor optical pen configured to focus different wavelengths at different distances proximate to a surface to be measured, wherein the chromatic range sensor optical pen is configured to be coupled to the measuring machine;
a calibration object comprising a calibration surface;
wherein the system is configured to:
utilize the motion controller to rotate the calibration object to achieve relative movement of the calibration surface in relation to the chromatic range sensor optical pen as a scan is performed by the chromatic range sensor optical pen, for which distance indicating data is determined as corresponding to distances between the chromatic range sensor optical pen and surface points on the calibration surface as the scan is performed; and
determine distance calibration data for the chromatic range sensor system based at least in part on the distance indicating data.

17. The system of claim 16, wherein the system is further configured to store the distance calibration data, and to subsequently perform a measurement process for determining a measurement distance which corresponds to a distance between the chromatic range sensor optical pen and a surface point on a surface, for which the measurement process comprises determining a distance indicating coordinate for the surface point based on a wavelength peak that results along a wavelength measurement axis from the measurement of the surface point, and for which the stored distance calibration data is utilized to correlate the distance indicating coordinate with the corresponding measurement distance.

18. The system of claim 16, wherein the distance indicating data that corresponds to the distances between the chromatic range sensor optical pen and each surface point comprises a distance indicating coordinate that is determined for each surface point based on a wavelength peak that results along a wavelength measurement axis from the measurement of the surface point.

19. A chromatic range sensor system for use with a measuring machine and a calibration object having a calibration surface, the chromatic range sensor system comprising:
a chromatic range sensor optical pen configured to focus different wavelengths at different distances proximate to a surface to be measured;
an illumination source configured to generate multi-wavelength input light comprising an input spectral profile that is input to the chromatic range sensor optical pen;
a wavelength detector comprising a plurality of pixels with respective pixel positions distributed along a wavelength measurement axis of the wavelength detector, wherein the chromatic range sensor system is configured such that, when the chromatic range sensor optical pen is operably positioned relative to a surface to perform measurement operations, the chromatic range sensor optical pen inputs the input spectral profile and outputs corresponding radiation to the surface and receives reflected radiation from the surface and outputs the reflected radiation to the wavelength detector; and
a processing portion configured to:
determine distance indicating data resulting from rotation of the calibration object by the measuring machine to achieve relative movement of the calibration surface in relation to the chromatic range sensor optical pen, wherein the relative movement of the calibration surface results in the chromatic range sensor optical pen performing a scan of a portion of the calibration surface, from which the distance indicating data is determined as corresponding to distances between the chromatic range sensor optical pen and surface points on the calibration surface as the scan is performed; and
determine distance calibration data based at least in part on the distance indicating data.

20. The chromatic range sensor system of claim 19, wherein the distance calibration data correlates distance-indicating coordinates with measurement distances.
